(19) United States
(12) Patent Application Publication
(10) Pub. No.: US 2026/0112173 A1
(43) Pub. Date: Apr. 23, 2026

(54) DRIVE THROUGH MONITORING SYSTEM

(71) Applicant: Xenial, Inc., Charlotte, NC (US)

(72) Inventors: Christopher Siefken, Charlotte, NC (US); Israel Rivera, Philadelphia, PA (US); James Davidson, Charlotte, NC (US); Andrew Grindstaff, Matthews, NC (US); Arjun Wadwalkar, Charlotte, NC (US); Brian Jackson, Seabrook, SC (US)

(73) Assignee: Xenial, Inc., Charlotte, NC (US)

(21) Appl. No.: 19/367,724

(22) Filed: Oct. 23, 2025

Related U.S. Application Data
(60) Provisional application No. 63/710,930, filed on Oct. 23, 2024.
(60) Provisional application No. 63/868,140, filed on Aug. 21, 2025.

(51) Int. Cl. G06V 20/52; G06T 7/246; G06T 7/70; G06T 11/60; G06V 10/25; G06V 20/62; G06V 40/16

(52) U.S. Cl. CPC G06V 20/52; G06T 7/248; G06T 7/70; G06T 11/60; G06V 10/25; G06V 20/625; G06V 40/161; G06T 2207/30196; G06V 2201/08

(57) ABSTRACT

A drive through system includes a sensor configured to obtain image data including an image of a lane of the drive through system and a controller. The controller is configured to determine whether the image includes a vehicle; identify, within the image, a personally identifiable feature; modify the image to remove the personally identifiable feature from the image and generate an anonymized image; and in response to a determination that the image includes a vehicle, provide the anonymized image to a remote device along with a request for the remote device to determine a characteristic of the vehicle.

### CROSS-REFERENCE TO RELATED PATENT APPLICATIONS

This application claims the benefit of and priority to U.S. Provisional Application No. 63/710,930, filed on Oct. 23, 2024, and U.S. Provisional Application No. 63/868,140, filed on Aug. 21, 2025, the entire disclosures of which are hereby incorporated by reference herein.

### FIELD

The present disclosure relates generally to drive through systems. More specifically, the present disclosure relates to vision systems for drive throughs. For example, artificial intelligence (AI)-driven vision models may detect staff and operational events, such as line busters and food runners, in drive-through (drive-thru) environments.

### BACKGROUND

Drive through systems include one or more lanes with a combination of display interfaces, microphones, speakers, and vehicle detection capabilities. When a customer arrives at the drive through system, the customer may communicate via a menu board or unit with an order taker to place their order. The customer then pulls around to pay and pick up the customer's order. Cameras may obtain image data of vehicles at the drive through system.

In typical drive through systems, the flow of orders and customer interactions is managed by manual observation or basic point-of-sale (POS) systems. These systems rely on employees to manually track service times, manage the engagement of staff such as line busters (e.g., who take or “intercept” orders before customers reach the menu board) and food runners (e.g., who deliver orders to vehicles). However, such methods are inefficient and prone to human error, particularly in high-traffic situations.

### SUMMARY

At least one embodiment relates to a drive through system. The drive through system includes a sensor configured to obtain image data including an image of a lane of the drive through system and a controller. The controller is configured to determine whether the image includes a vehicle; identify, within the image, a personally identifiable feature; modify the image to remove the personally identifiable feature from the image and generate an anonymized image; and in response to a determination that the image includes a vehicle, provide the anonymized image to a remote device along with a request for the remote device to determine a characteristic of the vehicle.

Another embodiment relates to a drive through system including a sensor configured to obtain image data including an image showing a vehicle within the drive through system, an order taking station configured to receive data corresponding to an order, and a controller. The controller is configured to determine, based on the image, a position of a vehicle; receive the data corresponding to the order from the order taking station; determine that the order should be associated with the vehicle based on the position of the vehicle; and provide an indication that the order is associated with the vehicle.

Yet another embodiment relates to a drive through system. The drive through system includes a sensor configured to obtain data indicating the presence of a vehicle within the drive through system; an order taking station configured to receive data corresponding to an order; and a controller configured to determine, based on information from the sensor, a position of a vehicle; receive the data corresponding to the order from the order taking station; determine that the order should be associated with the vehicle based on the position of the vehicle; and provide an indication that the order is associated with the vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a top view of a drive through system including cameras that monitor vehicles and employees, according to an exemplary embodiment.

FIG. 2 is a block diagram of a control system of the drive through system, according to an exemplary embodiment.

FIG. 3 is a block diagram of a method for tracking the vehicles and the employees of the drive through system of FIG. 1, according to an exemplary embodiment.

FIG. 4 is a frame of image data captured at a first time, according to an exemplary embodiment.

FIG. 5 is a frame of image data captured at a second time, according to an exemplary embodiment.

FIG. 6 is a modified version of the frame of image data of FIG. 5 that highlights potential areas of interest, according to an exemplary embodiment.

FIG. 7 is a cropped version of the frame of image data of FIG. 6, according to an exemplary embodiment.

FIG. 8 is a frame of image data including a region of interest and a series of predefined zones, according to an exemplary embodiment.

FIG. 9 is a modified version of the frame of image data of FIG. 8 that includes bounding boxes and masks highlighting a vehicle and an employee, according to an exemplary embodiment.

FIG. 10 is a cropped version of the frame of image data of FIG. 9, according to an exemplary embodiment.

FIG. 11 is a frame of image data that has been cropped to fit a vehicle and anonymized, according to an exemplary embodiment.

FIG. 12 is a frame of image data that has been cropped to fit a vehicle and anonymized, according to another exemplary embodiment.

FIG. 13 is a block diagram of the control system of FIG. 2, according to an exemplary embodiment.

FIG. 14 is a frame of image data showing a portion of a drive through with predefined areas for associating employees with vehicles, according to an exemplary embodiment.

FIG. 15 is a frame of image data showing the portion of the drive through of FIG. 14 populated with vehicles and an employee, according to an exemplary embodiment.

FIG. 16 includes for frames of image data each showing different portions of the drive through of FIG. 14, according to an exemplary embodiment.

FIG. 17 is a block diagram of an ordering and fulfilment process for a drive through system, according to an exemplary embodiment.

FIG. 18 is a screenshot of a system overview interface including a performance metric section, according to an exemplary embodiment.

FIGS. 19A and 19B are screenshots of an editing interface for modifying the system overview interface of FIG. 18, according to various exemplary embodiments.

FIG. 20 is a performance metric section for a system overview interface, according to another exemplary embodiment.

FIG. 21 is a screenshot of a window order taking interface, according to an exemplary embodiment.

FIGS. 22 and 23 are screenshots of a line buster interface in various states, according to an exemplary embodiment.

FIGS. 24 and 25 are screenshots of order customization screens for use with the line buster interface of FIG. 22, according to various exemplary embodiments.

FIGS. 26 and 27 are screenshots of a mobile order check in interface for use with the line buster interface of FIG. 22 in various states, according to an exemplary embodiment.

FIGS. 28-31 are screenshots of the line buster interface of FIG. 22 in various states.

FIG. 32 is a screenshot of a kitchen interface, according to an exemplary embodiment.

FIGS. 33-35 are screenshots of vehicle sections of the kitchen interface of FIG. 32, according to various exemplary embodiments.

FIG. 36 is a screenshot of a kitchen interface, according to another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a drive through system includes a vision system that tracks the movement of employees and vehicles throughout the drive through system. The vision system includes cameras that regularly provide image data showing the vehicles and the employees. A local controller of the vision system receives and processes the image data from the cameras. For a given frame of image data, the local controller may detect areas where motion has occurred relative to a previously processed frame of image data. The local controller may crop the image to include only areas where motion is detected in order to minimize processing of image sections that will not yield higher-value (e.g., actionable) information. The local controller may analyze the cropped image to identify objects of interest (e.g., vehicles and employees) within the image. The local controller may anonymize the image by erasing faces, license plates, or other sensitive information to ensure customer and employee privacy.

The local controller may provide the cropped and anonymized image data to a remote, third-party cloud computing system that is better suited to certain image processing functions than the local controller. The local controller may also send a request for the cloud computing system to assign labels to the image data. By way of example, the local controller may provide image data that is believed to contain an image of a vehicle to the cloud computing system, along with a request for the cloud computing system to provide a vehicle type, a vehicle color, a vehicle make, and a vehicle model of the provided vehicle. The cloud computing system may analyze the image data and provide labels indicating the desired information. Alternatively, the local controller may assign the labels without the use of the cloud computing system. The local controller may determine that the processing should occur locally in response to a failed connection between the local controller and the cloud computing system. Accordingly, the processes described herein may be performed by the local controller, by the cloud computing system, or by a combination of the local controller and the cloud computing system.

A series of zones may be predefined within a field of view of each camera. Each zone may represent an expected position that a vehicle would occupy as the vehicle moves throughout the drive through system. The local controller may analyze the positions of the identified vehicles relative to the zones and determine which zone, if any, the vehicle occupies. The occupied zone may indicate a current stage of an ordering and fulfillment process. By way of example, if a vehicle occupies a zone near an ending location of the drive through, an order associated with the vehicle has likely already been fulfilled. If the vehicle is determined to be outside of the zone, the vehicle may not currently be participating in the ordering and fulfillment process and may be ignored by the local controller. The local controller may use information from multiple cameras to track the movement of the vehicles as the vehicles move throughout the drive through system.

The local controller may identify the positions and orientations of employees throughout the drive through system. If an employee is determined to be in close proximity to a vehicle and facing the vehicle, then the local controller may associate the employee with the vehicle. This association may indicate that the employee is assisting a customer of the vehicle (e.g., by taking an order).

### Drive Through System

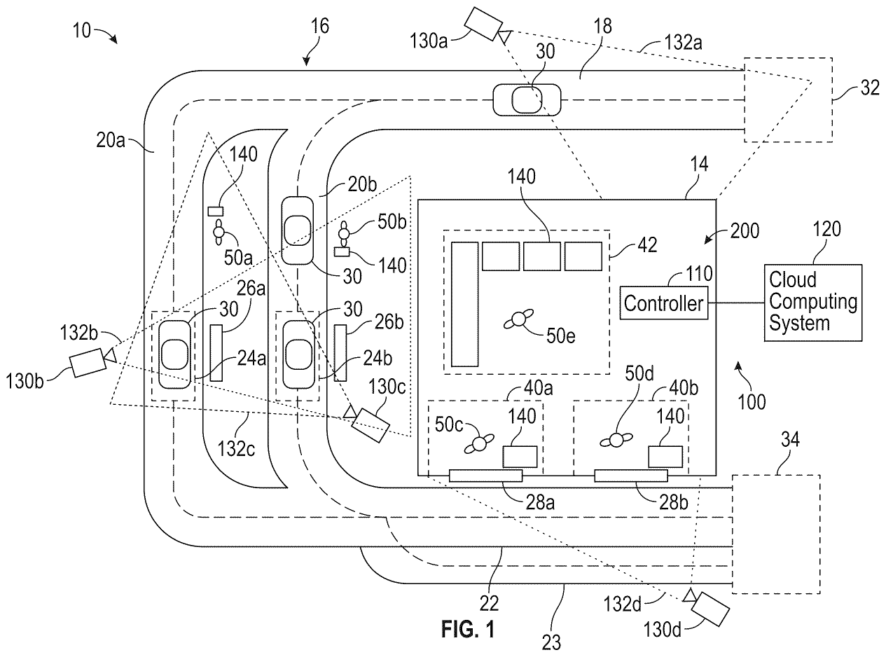

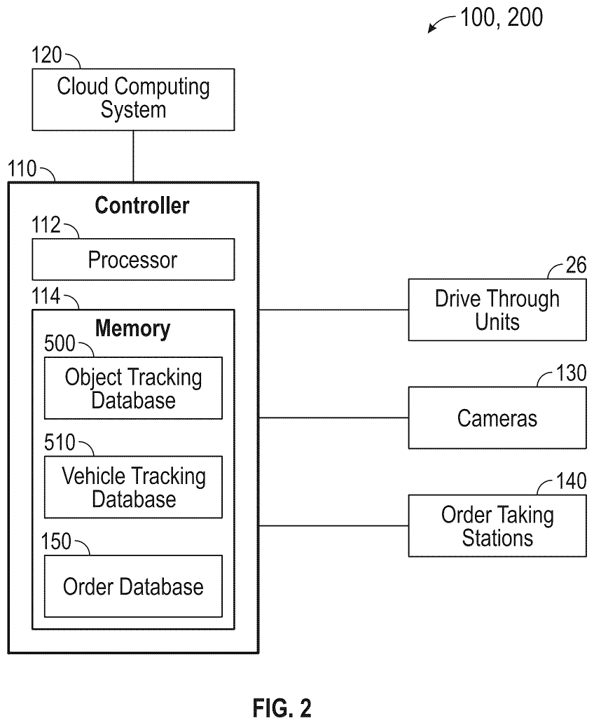

Referring to FIGS. 1 and 2, a drive through system 10 for a store 14 (e.g., a restaurant, a diner, a fast food restaurant, an establishment, etc.) includes a lane system 16 (e.g., a starting lane, one or more ordering lanes where a transaction such as a point of sale (POS) transaction may be conducted or initiated, ordering lanes where customers may communicate with employees of the store 14, etc.), a starting location 32 (e.g., an entrance), and an ending location 34 (e.g., an exit). The starting location 32 may be a zone or area at which one or more customers (e.g., customers in vehicles, shown as vehicles 30) enter the lane system 16. The lane system 16 includes an entry lane 18, a first order lane 20a, a second order lane 20b, a pickup lane 22, and/or one or more escape lanes 23. In other embodiments, the lane system 16 includes more or fewer order lanes (e.g., only the first order lane 20a). The pickup lane 22 (e.g., an exit lane) may extend along a side of the store 14 including one or more pickup windows, shown as first window 28a and second window 28b, such that customers (e.g., vehicles 30) may access the different windows 28 to pick up their orders from the store 14. The term “window” is used broadly to mean a customer-store interface which is not limited to those with a physical screen or barrier.

The escape lanes 23 (e.g., one or more exit lanes) extend along the other lanes (e.g., along the order lanes 20, along the pickup lane 22, etc.) and provide an alternative space for the vehicles 30 to exit the system 10. The one or more escape lanes 23 may connect with the ending location 34. In some embodiments, the one or more escape lanes 23 may be used by a vehicle 30 whose driver wishes to leave the system 10 early (e.g., without completing an order, when waiting for another vehicle 30 ahead of the vehicle 30 to complete an order, etc.).

The starting location 32 and the ending location 34 may define starting and ending points for customers, with the order lanes 20 defining different paths between the starting location 32 and the ending location 34. In some embodiments, each of the order lanes 20 defines a corresponding order zone 24 at which the customer may place an order for pickup at one of the windows 28. In some embodiments, the first order lane 20a includes a first order zone 24a, and the second order lane 20b includes a second order zone 24b. Each of the order zones 24 includes a corresponding drive through unit 26 (e.g., a menu board, a kiosk, a field communications unit, an order placement unit at which a customer may place an order, etc.) which facilitates communications between the customer at the order zones 24 and personnel of the store 14, as well as a display screen or signage indicating available items for purchase, and order or POS information (e.g., a number of items, corresponding cost, total cost, tax, etc., for an ongoing order). In some embodiments, the first order lane 20a includes a first drive through unit 26a, and the second order lane 20b includes a second drive through unit 26b. In some embodiments, the order lanes 20 define one or more paths that include a series of discrete geometric forms (e.g., polygonal shapes, curvilinear shapes) mapped to different physical locations along the order lanes 20. The series of geometric forms may match between multiple cameras (e.g., cameras 130) that have different fields of view in order to facilitate awareness, identification, and tracking of vehicles 30 along the one or more paths between the starting location 32 and the ending location 34.

The store 14 includes various areas housing personnel that support operation of the store 14. The store 14 includes a pair of rooms or areas, shown as window areas 40, each associated with one of the windows 28. Specifically, the window areas 40 include a first window area 40a from which the window 28a may be accessed and a second window area 40b from which the window 28b may be accessed. In some embodiments, the window 28a and the window area 40a are assigned as a payment window where an employee receives currency (e.g., cash, credit cards, debit cards, etc.) from a customer (e.g., in a vehicle 30) as payment for a product provided by the store 14. In some such embodiments, the window 28b and the window area 40b are assigned as a pickup window where an employee provides the product to the customer (e.g., in a vehicle 30). In other embodiments, the first window 28a, the second window 28b, the window area 40a, and the window area 40b are all assigned as pickup windows. In such an embodiment, payment may be taken elsewhere (e.g., through an online order, by employees while the vehicles 30 is within one of the order lanes 20).

The store 14 further includes a product storage and preparation space, shown as kitchen 42. The kitchen 42 may store products that are later provided to customers within the vehicles 30. The kitchen 42 may store the products in their final form, ready for delivery to the customers (e.g., sealed beverages, premade food products, silverware, bags, etc.). Additionally or alternatively, the kitchen 42 may include equipment to facilitate preparing the products for delivery to the customers (e.g., ovens, fryers, griddles, stoves, knives, blenders, etc.).

As shown in FIG. 1, the drive through system 10 may be associated with various staff, employees, or personnel, shown as employees 50, spread throughout the drive through system 10. By way of example, the employees 50 may be employed by an operator of the store 14 and may be assigned to perform various tasks associated with operation of the store 14. As shown, an employee 50a and an employee 50b are positioned along the first order lane 20a and the second order lane 20b, respectively. The employee 50a and the employee 50b may be assigned to take customer orders, take payment from the customers, or otherwise perform tasks that facilitate moving the vehicles 30 through the drive through system 10. An employee 50c and an employee 50d are positioned within the window area 40a and the window area 40b, respectively. The employee 50c and the employee 50d may be assigned to take payment from the customers, fulfill customer orders by providing products to the vehicles 30, or otherwise facilitate moving the vehicles 30 through the drive through system 10. An employee 50e is positioned within the kitchen 42 and may be assigned to retrieve and/or prepare products to fulfill orders.

Referring to FIGS. 1 and 2, the drive through system 10 includes a communications system, POS system, vision system, tracking system, or control system, shown as shown as control system 100. The control system 100 may facilitate collection and analysis of data regarding operation of the drive through system 10. By way of example, the control system 100 may facilitate tracking the movement of each vehicle 30 throughout the lane system 16. By way of another example, the control system 100 may facilitate tracking the movement of each employee 50 outside of the store 14. The control system 100 may facilitate fulfilment of orders from customers. By way of example, the control system 100 may receive customer orders, take customer payments, initiate preparation of products, and manage distribution of purchased products to the vehicles 30.

In some embodiments, the drive through units 26 are integrated via one or more POS systems. The control system 100 includes a local controller, shown as controller 110, that controls operation of the control system 100. The controller 110 includes a processing circuit, shown as processor 112, and a memory device, shown as memory 114. The memory 114 may contain one or more instructions that, when executed, cause the controller to perform one or more of the operations discussed herein. In some embodiments, the controller 110 includes multiple processing circuits in communication with one another that collectively perform the tasks described herein. By way of example, the controller 110 may include a first processing circuit that handles operation of a kitchen (e.g., providing instructions to prepare orders), a second processing circuit that handles operation of a vision system (e.g., tracking vehicles 30), and a third processing circuit that functions as a POS system (e.g., managing payment and orders). The controller 110 may be a local controller that is located within or nearby the store 14. Accordingly, the controller 110 may be capable of controlling operation of the system 10 even if an external network connection (e.g., to the Internet) degrades or fails.

The controller 110 is in communication with an external controller, server, or third-party system, shown as cloud computing system 120. In some embodiments, the cloud computing system 120 is positioned remotely from the controller 110 (e.g., remote from the store 14). The controller 110 may include a communication interface (e.g., a wired network interface, a wireless network interface, a cellular receiver, etc.) that facilitates communication between the controller 110 and the cloud computing system 120. By way of example, the controller 110 may communicate with the cloud computing system 120 through the Internet.

In some embodiments, the cloud computing system 120 is capable of performing certain tasks more effectively (e.g., more quickly, with a greater accuracy, etc.) than the controller 110. By way of example, the cloud computing system 120 may utilize computational strategies that are not available to the controller 110. By way of another example, the cloud computing system 120 may have greater processing power than the controller 110. Accordingly, it may be desirable to delegate certain tasks (e.g., object classification based on image data) to the cloud computing system 120. In some embodiments, some or all of the tasks described herein may be performed by the controller 110, by the cloud computing system 120, or a combination of the controller 110 and the cloud computing system 120.

In some embodiments, the cloud computing system 120 is operated by a third-party service different from the operator of the store 14. By way of example, the store 14 may be owned and operated by a first company that specializes in preparing and serving food products, and the cloud computing system 120 may be owned and operated by a second company that specializes in image recognition. The second company may offer image recognition services to multiple stores 14 and/or for multiple different applications. In some embodiments, the cloud computing system 120 and the controller 110 are operated by the same entity, but the cloud computing system 120 is utilized by multiple stores 14. By way of example, it may be advantageous to provide a series of controllers 110 locally integrated with the stores 14 and each having a relatively low processing capability and a centralized cloud computing system 120 with relatively high processing capability. In this way, the processing capability of the cloud computing system 120 may be accessed by multiple stores 14.

As shown in FIGS. 1 and 2, the control system 100 includes one or more imaging devices or image sensors, shown as cameras 130. The cameras 130 are positioned throughout the drive through system 10 (e.g., near the lane system 16 and the store 14) and configured to capture image data including images of vehicles 30 and employees 50. The control system 100 may utilize the image data from the cameras 130 to identify and track the vehicles 30 and/or the employees 50 as the vehicles 30 and the employees 50 travel throughout the drive through system 10. By way of example, the cameras 130 may monitor each of the vehicles 30 and provide image data indicating the current positions of vehicles 30 along the lane system 16. By way of another example, the cameras 130 may monitor the employees 50 (e.g., the employee 50a and the employee 50b) and provide image data indicating the current positions of the employees 50 throughout the drive through system 10.

In some embodiments, the control system 100 includes another type of imaging device or image sensor in place of or in addition to the cameras 130. By way of example, the control system 100 may receive image data from a LiDAR sensor, a radar sensor, an ultrasonic sensor, a pressure sensor, or another type of sensor, or any combination thereof. Such image data may indicate the shape, size, and/or relative positions of objects in range of the sensor. The image data from a sensor may be used by the control system 100 in a similar manner to the image data from a camera 130.

The cameras 130 may be operatively coupled to the controller 110 over a network to transfer the image data from the cameras 130 to the controller 110 for processing. In some embodiments, the cameras 130 are in communication with the controller 110 through a wired network. In some such embodiments, the cameras 130 are operatively coupled to the controller 110 through wired Ethernet connections. The Ethernet connections may also provide electrical energy to power the cameras 130 (e.g., as a power over Ethernet configuration). In other embodiments, the cameras 130 are operatively coupled to the controller 110 through a wireless connection (e.g., through Bluetooth, Wi-Fi, etc.).

In some embodiments, each of the cameras 130 meet certain criteria to ensure optimal system performance. The cameras 130 may each have at least a 4K image resolution (e.g., an image resolution of at least 3840 pixels by 2160 pixels). The cameras 130 may each be capable of capturing at least 10 frames of image data per second (e.g., have a refresh rate of at least 10 frames per second). The cameras 130 may each have a viewing angle between 31 degrees and 105 degrees. The cameras 130 may be capable of optical zoom. The cameras 130 may be capable of capturing color images. The cameras 130 may include spotlights to facilitate capturing color images in low light conditions (e.g., at night). The cameras 130 may be weatherproof to meet an IP67 certification.

As shown in FIG. 1, the cameras 130 include a first camera 130a positioned near the entry lane 18. The cameras 130 include a second camera 130b positioned near the first order lane 20a. The cameras 130 include a third camera 130c positioned near the second order lane 20b. The cameras 130 include a fourth camera 130d positioned near the pickup lane 22. In other embodiments, the control system 100 includes more or fewer cameras 130, or the cameras 130 are otherwise positioned.

Each of the cameras 130 has a field of view 132 within which the camera is capable of capturing image data. The boundaries of each field of view 132 may represent the furthest positions where an object can be detected by the camera 130. Each field of view 132 may expand (e.g., have a greater width) as the field of view 132 extends away from the corresponding camera 130.

As shown in FIG. 1, the first camera 130a has a first field of view 132a that includes the starting location 32 and a portion of the entry lane 18 near the starting location 32. Accordingly, the first camera 130a may be useful for monitoring vehicles 30 entering the lane system 16. The second camera 130b has a second field of view 132b that includes portions of the first order lane 20a and the second order lane 20b. The third camera 130c has a third field of view 132c that includes portions of the first order lane 20a and the second order lane 20b. Accordingly, the second camera 130b and the third camera 130c may be useful for monitoring vehicles 30 that are about to order, that are in the process of ordering, or that have recently ordered. The second camera 130b and the third camera 130c may be useful for monitoring employees 50 that are assisting customers with ordering. The fourth camera 130d has a fourth field of view 132d that includes a portion of the pickup lane 22 near the windows 28 and the ending location 34 and a portion of the one or more escape lanes 23 near the ending location 34. Accordingly, the fourth camera 130d may be useful for monitoring vehicles 30 that are about to pay or pick up an order, that are in the process of paying or picking up an order, or that have recently paid or picked up an order. The fourth camera 130d may also be useful for monitoring vehicles 30 that are about to leave the lane system 16, either through the pickup lane 22 or the one or more escape lanes 23.

The fields of view 132 may overlap one another or may be separate from one another. As shown in FIG. 1, the first field of view 132a is separate from the other fields of view 132. There may be an unmonitored gap along the lane system 16 between (a) the first field of view 132a and (b) the second field of view 132b and the third field of view 132c. The second field of view 132b and the third field of view 132c overlap one another. The fourth field of view 132d is separate from the other fields of view 132. There may be an unmonitored gap along the lane system 16 between (a) the second field of view 132b and the third field of view 132c and (b) the fourth field of view 132d.

Referring again to FIGS. 1 and 2, the control system 100 includes the drive through units 26 in communication with the controller 110. The order zones 24 may include a space or surface of the order lane 20 for the vehicles 30 to pull up and place an order through the drive through units 26. The drive through units 26 include a display screen visible to a customer within the corresponding order zone. The display screen of the drive through units 26 may display a current order, items in the order, and cost of the order or other aspects of an order property, alone or in any combination. The drive through units 26 may also include microphones configured to capture audio (e.g., spoken audio) from the customer and transmit data (audio data, audio signals) to the employee 50 that is taking the customer's order via a corresponding channel of the control system 100 for the order lane 20 of the order zone 24.

The control system 100 further includes one or more input devices, shown as order taking stations 140, in communication with the controller 110. In some embodiments, the order taking stations 140 are stationary (e.g., have a permanent position). As shown in FIG. 1, an order taking station 140 is positioned within each of the window areas 40 near the windows 28. In some embodiments, the order taking stations 140 are portable (e.g., configured as a smartphone or tablet with a portable power supply). As shown in FIG. 1, the employee 50a and the employee 50b may each carry an order taking station 140 to facilitate taking orders manually. The order taking stations 140 may include a touch screen or user interface configured to both display image data (e.g., a graphical user interface, a menu, selectable options for an order or point of sale (POS), etc.), and receive user inputs from a corresponding employee of the store 14 to add items to an order or POS.

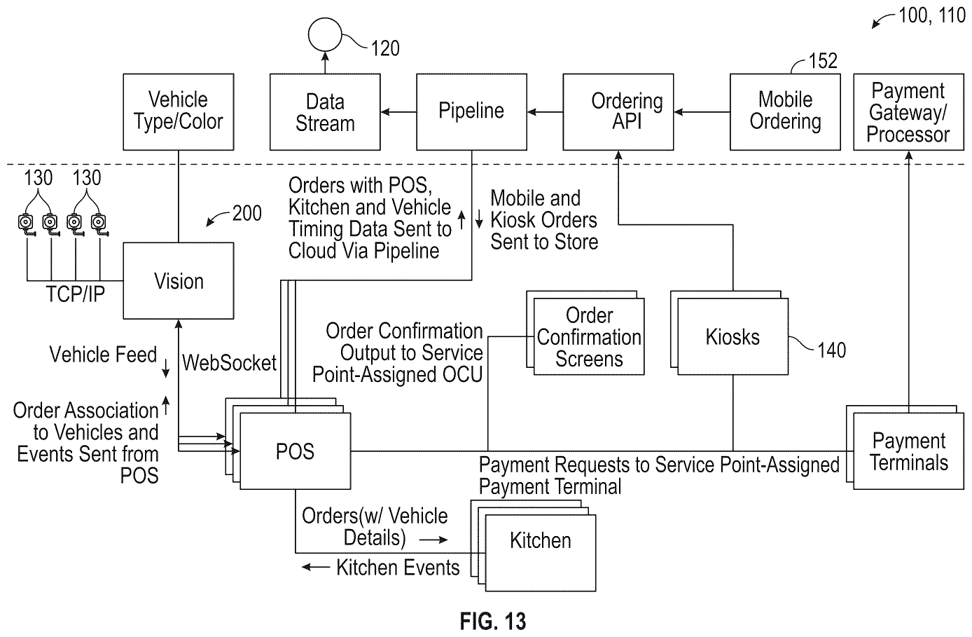

Referring to FIG. 13, the control system 100 is shown according to an exemplary embodiment. As shown, the control system 100 may handle data that facilitates various activities throughout the drive through system 10, such as POS functionality, kitchen management, taking payment and orders, and vision tracking.

In some embodiments, the control system 100 functions as a POS system to receive orders, take payment, and coordinate fulfillment of orders. The controller 110 may include an order database 150 (e.g., in the memory 114) that contains data corresponding to orders that are in progress or completed. A customer may place an order indicating a quantity and type of product that is desired (e.g., a double cheeseburger and fries, two green teas, a large oat milk latte, etc.). The controller 110 may add the order to the order database 150. In some embodiments, the customer indicates their order verbally to an employee 50, and the employee enters the order through an order taking station 140. The customer may communicate directly with an employee 50 (e.g., the employee 50a positioned adjacent a vehicle 30), or the customer may communicate indirectly with an employee 50 through a drive through unit 26 (e.g., through a microphone of a drive through unit 26). In some embodiments, the customer places an online order or mobile order through a user device 152 (e.g., a smartphone or tablet). The user device 152 may communicate with the controller 110 through the over the Internet or through another type of connection.

The controller 110 may monitor a payment status for each order and store the payment status in the order database 150. A customer may provide payment to an employee 50 (e.g., through a debit card or credit card, through cash, etc.). The employee 50 may record when the payment has been completed through an order taking station 140. Additionally or alternatively, the customer may provide payment online (e.g., over the Internet through the user device 152).

The controller 110 may monitor a fulfillment status for each order and store the fulfillment status in the order database 150. Additionally, the controller 110 may provide instructions to employee 50 to facilitate fulfilment of orders. In response to payment for an order being received, the controller 110 may provide instructions to the employees 50 indicating what products will be required to fulfill the order. By way of example, the controller 110 may provide instructions to the employee 50e through an order taking station 140 to begin preparing products within the kitchen 42 to fulfill the order. The controller 110 may provide instructions to the employee 50c and/or the employee 50d indicating which products should be provided to fulfill the order. When the complete order has been provided to the customer, an employee 50 may indicate that the order is fulfilled through an order taking station 140, and the controller 110 may record the order status as fulfilled in the order database 150.

The control system 100 may include or act as a drive through monitoring system, image recognition system, image analysis system, tracking system, or vision system, shown as vision system 200. The vision system 200 may be implemented on the controller 110 and/or the cloud computing system 120 based on image data received from the cameras 130. In some embodiments, the vision system 200 is configured to integrate with one or more POS units of the control system 100, such as the order taking stations 140. By way of example, the vision system 200 may be provided as an upgrade or addon to an existing point of sale system. The vision system 200 is configured to track vehicles, personnel, and/or customers through the drive through system 10 (e.g., along different lanes) and integrate with a POS system.

In some embodiments, the vision system 200 provides performance metrics for the drive through system 10 (e.g., time to service statistics). The vision system 200 may track the progress of each vehicle 30 through the system 10. The vision system 200 may record a time when each vehicle 30 enters the drive through system 10 and a time when each vehicle 30 exits the drive through system 10. Based on the recorded times, the vision system 200 may determine an amount of time required for the vehicle 30 to pass through the system 10 (e.g., a time to service). It may be desirable to reduce this amount of time (e.g., to increase the number of customers that can be serviced by the drive through system 10 and reduce customer wait times). Accordingly, the determined amount of time (e.g., an average amount of time across multiple vehicles 30) may be used to evaluate how well the system 10 and the employees 50 are performing.

The vision system 200 may trigger notifications to the employees 50. In some embodiments, the vision system 200 is configured to notify the employees 50 regarding the presence of a vehicle 30 at one of the drive through units 26. In some embodiments, the vision system 200 is configured to identify which vehicle has arrived at a pickup window and notify associated employees 50 regarding which order the vehicle at the pickup window should receive. In some embodiments, the vision system 200 is configured to prompt the employees 50 to open another order taking or drive through lane. In some embodiments, the vision system 200 is configured to notify the employee 50e regarding an influx of vehicles 30 to the drive through system 10 to prompt the kitchen employee 50e to begin preparing food in advance.

In some embodiments, the vision system 200 utilizes an artificial intelligence (AI)-driven vision model that is trained and implemented to detect vehicles and personnel (e.g., employees, staff, etc.). The personnel may include line busters (e.g., individuals taking orders in advance of the menu board, staff facilitating order flow) and food runners (e.g., employees delivering orders to vehicles, staff assisting with fulfillment) in the system 10. The model can determine how long the engagement with the line busters and food runners lasts for future concepts, improving ordering processes. Additionally, the vision model system can track the speed of service across the system 10, providing visibility and allowing for determination of metrics and analysis of performance at the drive-through system. In some implementations, the full process of a vehicle 30 moving through the system 10 can be tracked to improve operational efficiency and reduce waiting times.

Generally, the vision model system (also referred to herein as the “vision model”) described herein can be implemented using various hardware configurations such as GPUs, CPUs (e.g., processing circuits, memory storing instructed, when executed by the processing circuits cause the processing circuits to perform object detection and tracking), AI accelerators, and/or any other hardware or cloud-based components configured to process real-time (or near real-time) visual data, detect and classify objects, and provide actionable insights for drive-thru operations.

The vision model system can include a set of interconnected neural networks for processing visual data and detecting objects within a drive-thru environment. The visual model system can include any one or more artificial intelligence models (e.g., machine learning models, supervised models, neural network models, deep neural network models), rules, heuristics, algorithms, functions, or various combinations thereof to perform operations including vehicle detection and order association, such as tracking vehicles as they move through different zones of the system 10. That is, the vision model can be a neural network trained to detect vehicles 30, and employees 50 in real-time. In some implementations, the vision model can output classification results (e.g., vehicle type, vehicle color, time spent in lane, and/or any engagement metrics). For example, the vision model system can identify how long a vehicle 30 has been waiting in line. In another example, the vision model system can detect the arrival of an employee 50 acting as a food runner and associate them with the appropriate vehicle 30. In some implementations, the output can be provided to a station 140 configured as a point of sale to perform order association. In some implementations, the output can be provided to various user interfaces to facilitate tracking of service times. In some implementations, the output can be provided to the cloud computing system 120 to perform further analytics and reporting.

In some implementations, the vision system 200 can maintain, execute, train, and/or update one or more machine-learning models during the encoding stage. In some implementations, the machine-learning model(s) can include any type of convolutional machine-learning models capable of processing visual input data (e.g., image data from multiple cameras) to identify vehicles and humans. For example, the machine-learning model(s) can be trained and/or updated to detect specific vehicle attributes (e.g., make, model, color), among other identifying factors. The machine-learning model(s) can be or include a transformer-based model (e.g., a generative pre-trained transformer (GPT) model). The machine-learning model(s) can be or include a recurrent neural network model, in some implementations. The vision system 200 can execute the machine-learning model to generate outputs. The vision system 200 can receive data to provide as input to the machine-learning model(s), which can include visual data (e.g., cameras, sensors, GPS data, order information, and/or any other inputs). The vision system 200 may utilize any of the machine-learning model implementations described herein, or any combination of the implementations.

The vision system 200 can include at least one neural network (e.g., vision model). The vision model can include an input layer, an output layer, and/or one or more intermediate layers, such as hidden layers, which can each have respective nodes. That is, the vision model can process the input data through multiple layers of transformations to identify attributes of vehicles and orders. For example, the input layer receives raw data from cameras. For example, the output layer generates predictions or classifications such as the identification of a specific vehicle type and/or a specific type of order or customer (e.g., mobile, line buster, and food runner). For example, the intermediate layers can process the data to extract features such as vehicle shape, color, and position.

In some implementations, the vision system 200 can configure (e.g., train, update, fine-tune, apply transfer learning to) the vision model by modifying or updating one or more parameters, such as weights and/or biases, of various nodes of the vision model responsive to analyzing estimated outputs of the vision model (e.g., generated in response to receiving training examples in a training dataset). The vision system 200 can be or include various neural network models, including models that can for operating on or generating data including but not limited to image data, video data, sensor data, audio data, speech data, or various combinations thereof.

In some implementations, the vision system 200 can be configured (e.g., trained, updated, fine-tuned, has transfer learning performed, etc.) based at least on the training data of the at least one training dataset. For example, one or more example images and/or video frames of vehicles 30 of the training data can be applied (e.g., by the vision system 200, or in a pre-training process performed by the vision model system or another system) as input to the vision system 200 to cause the vision model system to generate an estimated output. The estimated output can be evaluated and/or compared with labels (or ground-truth data) of the training data that correspond with the one or more example images (e.g., vehicle type, color, make) and/or timestamps of vehicle arrivals (e.g., time spent in queue, engagement start, engagement end, and so on), and the vision system 200 can be updated based at least on the evaluation and/or comparison. For example, based at least on an output of vehicle classification, one or more parameters (e.g., weights and/or biases) of the vision model of the vision system 200 can be updated.

### Tracking Method

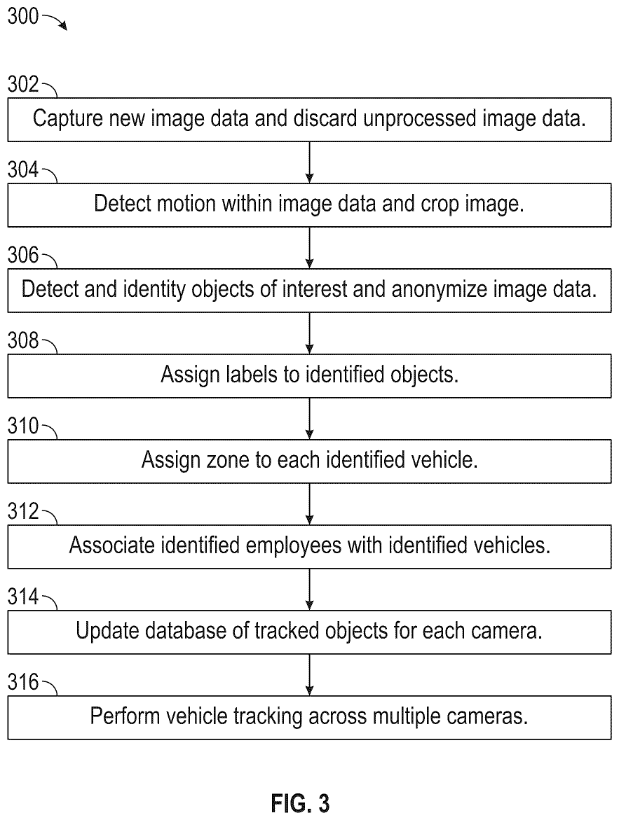

Referring to FIG. 3, drive through monitoring method is shown as a method 300 for tracking the vehicles 30 and employees 50 throughout the drive through system 10, according to an exemplary embodiment. The method 300 may be performed by the vision system 200. When performing the method, the vision system 200 may utilize the cameras 130 to capture image data showing various parts of the lane system 16. The captured image data may be analyzed by the controller 110 and/or the cloud computing system 120 to identify each of the vehicles 30, as well as their locations within the lane system 16. The vision system 200 may use multiple sets of the image data taken over time to track the progress of the vehicles 30 throughout the lane system 16. The vision system 200 may also use the image data to track employees 50 (e.g., the employee 50a, the employee 50b, etc.).

### Camera Stream

In step 302 of the method 300, the cameras 130 capture new image data including images of the drive through system 10, and the controller 110 discards older unprocessed image data. The cameras 130 may provide the image data as a stream to the controller 110 for further processing. Each of the cameras 130 may have a different field of view 132 that is captured in the corresponding image. Accordingly, by capturing image data from each of the cameras 130, the vision system 200 may have access to image data representing a large portion or all of the lane system 16.

The stream of image data provided by the cameras 130 to the controller 110 may have an associated data transmission rate (e.g., bandwidth, bitrate, etc.) required for the image data to be received by the controller 110. The required bitrate may vary based on certain factors, such as the image quality (e.g., resolution) of the image data, the number of cameras 130 providing the image data, and the refresh rate (e.g., in frames per second) of the image data. The networking hardware connecting the cameras 130 to the controller 110 may have a maximum bitrate that the networking hardware is capable of transmitting. Accordingly, it can be desirable to balance image quality and refresh rate to stay within limitations of the networking hardware. In some embodiments, the vision system 200 includes six of the cameras 130, and each camera 130 provides image data at 4K resolution and with a 10 frames per second refresh rate.

The controller 110 may add the received image data from each camera to a queue for processing. The image data captured by each camera 130 may be organized in separate queues. The controller 110 may process the image data from the different queues in parallel. Processing the image data may require a large amount of processing power. Accordingly, under certain circumstances (e.g., where the image processing is unusually complex, where the controller 110 is operating slowly, etc.), the controller 110 may not be capable of processing the image data as quickly as it is received from the cameras 130. Accordingly, such embodiments can avoid sequential handling of each captured frame of image data and therefore avoid a delay or lag in processing of the image data.

To avoid lag in image processing, the controller 110 may selectively delete or ignore certain frames of image data. The controller 110 may place each frame of image data for a given camera 130 into a queue for image processing. The unprocessed frames may be organized in the order that they were captured, such that the most recent frame captured by a camera 130 is always the first in the queue for that camera 130. When selecting a frame for image processing, the controller 110 utilizes the most recent unprocessed frame in the queue. If there are additional, older frames in the queue, the controller 110 deletes those older frames without further processing. When finished processing that first frame, the controller 110 then again selects the most recent unprocessed frame and deletes any older frames. In this way, the controller 110 processes as much of the image data as possible without introducing any lag. This process may help to ensure that the controller 110 processes the image data from all of the cameras 130 in sync with one another.

### 2. Motion Detection

In step 304 of the method 300, the vision system 200 detects motion within the image data and crops the image. Step 304 is performed separately for each camera 130. The controller 110 compares the most recently processed frame of image data from a camera 130 with the most recent unprocessed frame of image data provided by that camera 130. By monitoring for changes between the two frames, the controller 110 may identify motion within the field of view 132 of the camera 130.

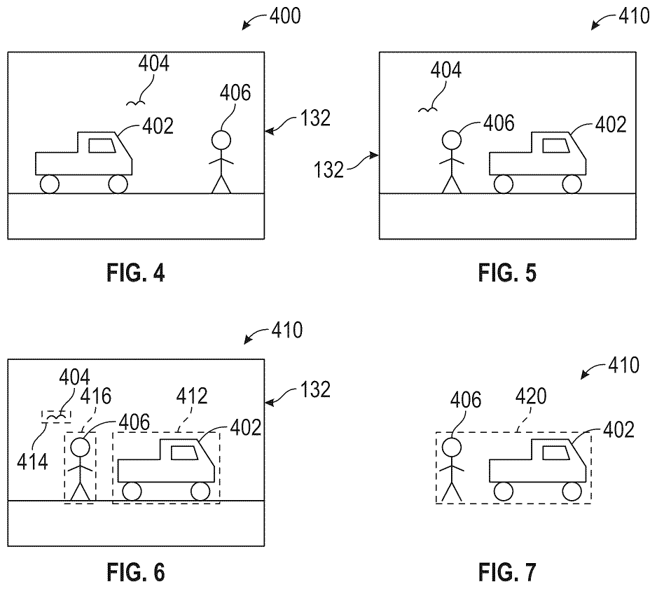

Referring to FIGS. 4-6, an example of the motion detection strategy is illustrated according to an exemplary embodiment. FIG. 4 illustrates a first, earlier frame 400 of image data captured by a camera 130. FIG. 5 illustrates a second, later frame 410 of image data captured by the camera 130. Both the earlier frame 400 and the later frame 410 represent the same field of view of the camera 130. The earlier frame 400 and the later frame 410 both include a relatively large object, shown as vehicle 402, a relatively small object, shown as bird 404, and an intermediate-sized object, shown as employee 406. The vehicle 402 may be an example of a vehicle 30. The employee 406 may be an example of an employee 50. As shown, the vehicle 402 has moved to the right and the bird 404 and the employee 406 have moved to the left within the field of view 132 between when the earlier frame 400 was captured and when the later frame 410 was captured.

Each frame is represented by a series of pixels (e.g., 3840 pixels by 2160 pixels). The controller 110 may compare each corresponding pixel between the earlier frame 400 and the later frame 410 to detect which pixels have changed. By way of example, the controller 110 may compare a color of a given pixel between the two frames and determine that the pixel has changed when the color has changed by a threshold amount. Areas or regions containing adjacent or contiguous pixels that have changed between the two frames are considered to be potential areas of interest containing objects that appear to have moved. As shown in FIG. 6, the controller 110 identifies a potential area of interest 412 corresponding to the vehicle 402, a potential area of interest 414 corresponding to the bird 404, and a potential area of interest 416 corresponding to the employee 406. The potential areas of interest may be the smallest rectangular areas that surround the areas of pixels that have changed.

The controller 110 may may evaluate the potential areas of interest to determine if greater than a threshold amount of motion has occurred between the earlier frame 400 and the later frame 410. By way of example, the controller 110 may evaluate the size of each potential area of interest to determine a size of the corresponding object. The vision system 200 may only be designed to track personnel and vehicles, so objects smaller than a human may not be of interest. The controller 110 may determine the size of an object based on a quantity of pixels within the potential area of interest. If the number of pixels is below a predetermined threshold number, the controller 110 may determine that the potential area of interest corresponds to a small object below a threshold size and ignore that potential area of interest. In the example of FIG. 6, the controller 110 may determine that the potential area of interest 412 and the potential area of interest 416 correspond to objects of sufficient size, but the potential area of interest 414 should be ignored.

Referring to FIG. 7, the controller 110 defines a region of interest 420 surrounding the potential areas of interest corresponding to objects of sufficient size. The region of interest may be the smallest rectangular area that surrounds the potential areas of interest corresponding to objects of sufficient size. As shown, the region of interest 420 includes the potential area of interest 412 and the potential area of interest 416. The controller 110 may then crop the later frame 410 to only include the pixels within the region of interest 420. By cropping the image in this way, the controller 110 may reduce the amount of image data that is required to be processed later, reducing the processing power required to process the image data.

In some situations, the controller 110 may not identify any potential areas of interest, or the controller 110 may only identify potential areas of interest that are below the threshold size. In such a situation, the controller 110 may determine that no significant motion was detected in the later frame (e.g., no motion was detected, only insignificant motion was detected, etc.). In response to a determination that the no significant motion was detected in the frame, the method 300 may terminate at step 304 and return to step 302 to begin processing new image data. In this way, the controller 110 may reduce the processing power required to process the image data by avoiding processing of image data that would not provide higher-value (e.g., actionable) updates to the positions of vehicles or personnel.

### 3. Object Detection and Segmentation

In step 306 of the method 300, the vision system 200 detects and identifies objects within the image data and anonymizes the image data. The controller 110 may utilize the region of interest identified in step 304 of the method and detect objects within the region of interest. In some embodiments, the controller 110 searches the entire region of interest for objects. In other embodiments, the controller 110 searches only the potential areas of interest that were identified as containing objects of sufficient size in step 304.

In some embodiments, the controller 110 utilizes a machine learning model trained to detect and identify objects within an image. By way of example, the machine learning model may be trained using a dataset optimized for vehicles, humans, faces, and license plates. In some embodiments, the controller 110 utilizes a You Only Look Once (YOLO) machine learning model. The machine learning model may provide an output with bounding boxes around each detected object, an assigned identity for the object (e.g., whether the object is a vehicle, a human, or another type of object), and a confidence score indicating a level of confidence with which the controller 110 was able to detect and identify the object. A high confidence score may indicate a high probability that the object was correctly detected and identified. In some embodiments, the machine learning model further provides an orientation of the detected object. By way of example, the controller 110 may determine a direction that an employee 50 is facing and/or a field of view of the employee 50.

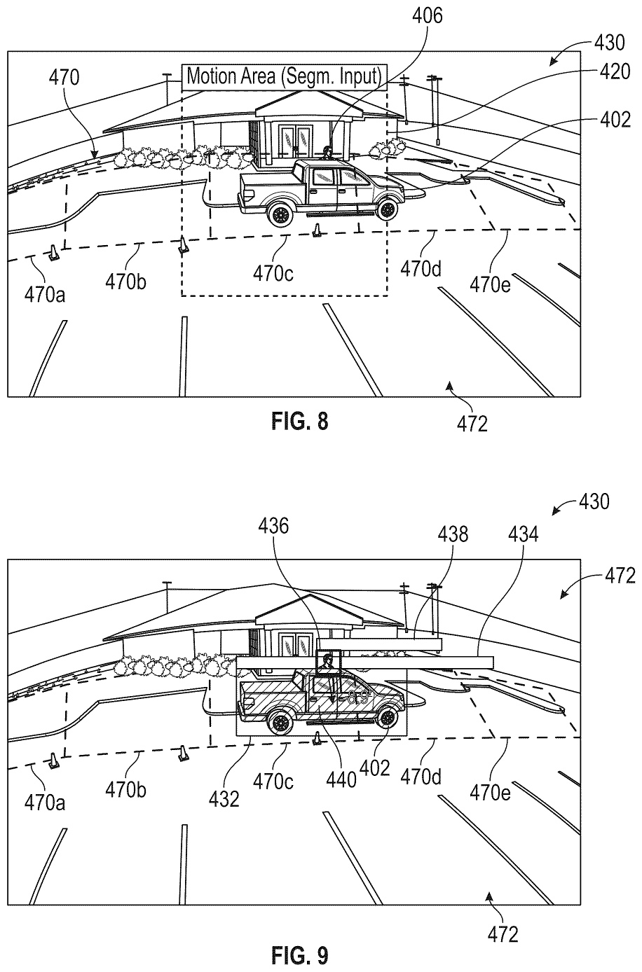

Referring to FIGS. 8 and 9, a frame of image data is shown as frame 430 according to an exemplary embodiment. FIG. 8 illustrates the frame 430 after the processing of step 304. As shown, the frame 430 includes a vehicle 402 and an employee 406. The employee 406 is positioned behind the vehicle 402 from the perspective of the camera 130, such that the body of the employee 406 is obscured, but the head of the employee 406 is visible. In this example, the vehicle 402 and the employee 406 were both determined to have been moving, and a region of interest 420 is drawn around the vehicle 402 and the employee 406.

The controller 110 processes the region of interest 420 using the machine learning model in step 306, and the output of the machine learning model is shown in FIG. 9. The controller 110 places a first bounding box 432 around the vehicle 402. The controller 110 provides a first label 434 associated with the first bounding box 432. As shown, the first label 434 includes the text “vehicle 0.92.” This indicates that the controller 110 has identified the object within the first bounding box 432 as a vehicle, and that the controller 110 has assigned a confidence score of 0.92 to this determination. A higher confidence score may indicate a greater probability of a successful determination.

The controller 110 places a second bounding box 436 around the employee 406. The controller 110 provides a second label 438 associated with the second bounding box 436. As shown, the second label 438 includes the text “human 0.29.” This indicates that the controller 110 has identified the object within the second bounding box 436 as a human, and that the controller 110 has assigned a confidence score of 0.29 to this determination. This confidence score is considerably lower than the confidence score for the first bounding box 432 (e.g., due to the employee 406 being obscured by the vehicle 402).

In some embodiments, the controller 110 proceeds beyond object detection and identification in step 306 and further segments the area within the identified bounding box. While the bounding boxes assigned by the controller 110 are sized to fit the corresponding objects, if the objects are not perfectly rectangular, the bounding box contains pixels that do not belong to the object. In order to segment the area within the bounding box, the controller 110 identifies the boundaries of the object and provides a mask locating the object at a pixel level. This mask identifies exactly which pixels correspond to the object and which pixels are part of the surroundings. This mask more accurately identifies the object, permitting the controller 110 to save processing power by avoiding image processing on pixels outside of the mask.

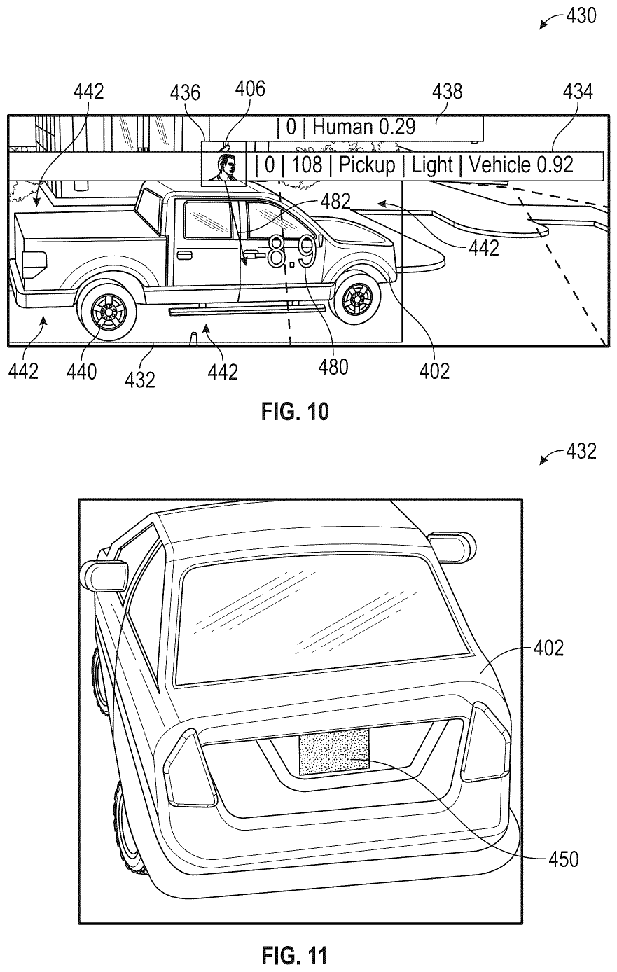

FIG. 10 shows the portion of the frame 430 of FIG. 9 including the first bounding box 432 and the second bounding box 436. As shown, the controller 110 identifies an object-containing area, shown as mask 440, that contains the object. The controller 110 may determine that the boundaries of the object correspond to the boundaries of the mask 440. A series of empty areas 442 extend between the mask 440 and the first bounding box 432. The empty areas 442 represent pixels that that do not belong to the object but would still be processed by the controller 110 if the controller 110 did not perform image segmentation.

While the vision system 200 may be used to track the movement of vehicles (e.g., vehicles 30) and individuals (e.g., employees 50) throughout the drive through system 10, the vision system 200 may be capable of accomplishing this using only general, high-level information regarding the vehicles and individuals (e.g., vehicle type, vehicle color, the last known location of the vehicle or individual, etc.). In some embodiments, certain data may be anonymized, redacted, extracted or otherwise removed from the image data. For example, personally identifiable information potential useful to identify a particular individual or vehicle can be removed. Such personally identifiable features may include portions of the image data corresponding to human faces and license plates.

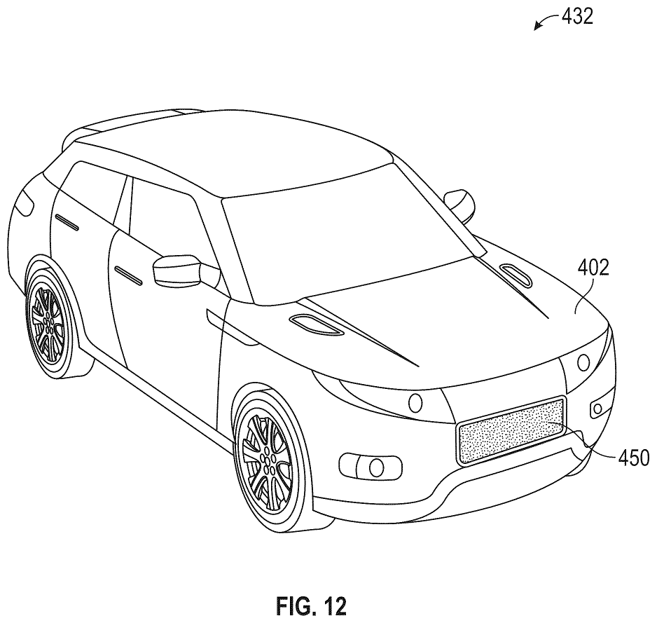

As part of step 306, the controller 110 can also use the machine learning model to identify portions of the image data containing personally identifiable features, such as faces or license plates. When the controller 110 identifies a face or license plate, the controller 110 can anonymize the image data by erasing (e.g., redacting, masking, excising, etc.) the pixels corresponding to the face or license plate. FIG. 11 is an example of a frame of image data that has been anonymized. As shown, the image content is cropped by the controller 110 to yield FIG. 11, including only a first bounding box 432 containing a vehicle 402. As part of step 306, the controller 110 performs the steps of (i) identifying a license plate region 450 of the image and (ii) anonymizing the image by replacing the pixels of the license plate region 450 with black pixels.

### 4. Object Classification

In step 308 of the method 300, the vision system 200 assigns labels to the objects identified in step 306. In some embodiments, the vision system 200 utilizes the entirety of a bounding box (e.g., the first bounding box 432) as an input in step 308. In other embodiments, the vision system 200 utilizes only the portion of the bounding box that is identified by a mask as corresponding to an object (e.g., the portion of the first bounding box 432 identified by the mask 440).

A label may indicate or represent one or more characteristics, properties, or classifications of an identified object. The labels may be selected from a predetermined list of labels (e.g., stored in the memory 114, stored in the cloud computing system 120, etc.). The labels may be used to identify the object after the image data has been anonymized. By way of example, a “vehicle” label may be selected to facilitate a user (e.g., an employee 50) quickly and easily identifying a particular vehicle 30 out of several vehicles 30 that are present in the lane system 16. By way of another example, a “human” label may indicate whether a detected human is an employee or a non-employee (e.g., a customer) and/or a type of employee (e.g., a line buster or a food runner).

In some embodiments, the vision system 200 applies vehicle labels that facilitate identifying a vehicle 30. In some embodiments, the vehicle labels include a vehicle type and a vehicle color. The vehicle type may indicate a type, category, or other classification of the vehicle 30 (e.g., a sedan, a car, a pickup truck, a sports car, a sport utility vehicle (SUV), a van, a camper, etc.). The vehicle color may indicate a main or primary color of the vehicle 30 (e.g., white, black, gray, red, green, etc.). Beneficially, both the vehicle type and the vehicle color can be quickly and easily determined visually by a user without requiring significant training. By using two vehicle labels for each vehicle 30, it may be unlikely that multiple cars having the same pair of vehicle labels are nearby one another the lane system 16, minimizing the likelihood of misidentifying a vehicle 30.

In some embodiments, the vehicle labels include a vehicle make and/or a vehicle model. The vehicle make may indicate a manufacturer of the vehicle 30 (e.g., BMW, Ford, Jeep, Honda, Toyota, Kia, etc.). The vehicle model may indicate a particular version or variant of the vehicle 30 produced by a particular manufacturer (e.g., a BMW 2 Series Coupe, a Ford F150, a Jeep Cherokee, a Honda Civic, a Toyota Camry, a Kia Telluride, etc.).

In some embodiments, the vision system 200 utilizes a machine learning model to determine the vehicle type for a given vehicle. The vision system 200 may apply the machine learning model to a portion of an image identified as containing a vehicle in step 206 and provide the vehicle type as an output. By way of example, the machine learning model may be trained using a dataset including vehicles and their corresponding type. In some embodiments, the vision system 200 utilizes a You Only Look Once (YOLO) machine learning model to determine the vehicle type. The vision system 200 may utilize a similar machine learning model to determine the vehicle make and/or the vehicle model for a given vehicle.

In some embodiments, the vision system 200 uses the portion of the image identified as containing a vehicle in step 206 to determine the vehicle color of the vehicle. The vision system 200 may determine the vehicle color by first determining a quantitative color value (e.g., hue, lamination, and saturation values) for each pixel of the input image. The vision system 200 may assign a color label to each pixel based on the determined color value. The assigned color labels may be selected from the predetermined list of labels. The vision system 200 may determine which of the assigned color labels is most predominant among the pixels and assign that color label as the vehicle color.

The vision system 200 can require a greater threshold (e.g., require a greater number of pixels having the same color label) when assigning color labels of black, white, or gray than when assigning color labels for other colors (e.g., red, blue, green, etc.). This greater threshold can cause the vision system 200 to have a greater certainty when assigning black, white or gray vehicle colors than when assigning the other vehicle colors. Reflections, lights, rims, tires, and glass may all register as black, white, or gray, which may otherwise lead to an erroneous assignment of a vehicle color without the more stringent threshold.

In some embodiments, the vision system 200 utilizes a machine learning model to determine the human type for a given human. The vision system 200 may apply the machine learning model to a portion of an image identified as containing a human in step 206 and provide the human type as an output. By way of example, the vision system 200 may evaluate the image data to search for a particular type of item worn or otherwise carried by an employee. An employee 50 may wear a high-visibility (e.g., reflective) vest, hat, or other garment specific to the store 14. An employee 50 may be carrying a tablet (e.g., an order taking station 140). An employee 50 may be carrying an order (e.g., a tray of food). If the vision system 200 identifies any of a predetermined list of recognized objects carried by a human, the vision system 200 may identify the human as an employee with an employee label. Otherwise, the vision system 200 may identify the human as a non-employee (e.g., a customer) with a non-employee label.

In some embodiments, the human type further includes an employee type for an identified employee 50. By way of example, the employee type may identify an employee 50 as a line buster or a food runner. In some embodiments, the vision system 200 identifies the employee type based on the type of object determined to be carried by the employee 50. By way of example, line busters may carry tablets and/or a first type of garment (e.g., a red shirt), and food runners may carry orders and/or another type of garment (e.g., a blue shirt). In some embodiments, the vision system 200 identifies the employee type based on the location of the employee 50. By way of example, line busters may be present within zones 470 that are closer to the starting location 32 (e.g., closer to the beginning of the drive through), and food runners may be present within zones 470 that are closer to the ending location 34 (e.g., closer to the end of the drive through).

### 5. Object Classification Third Party Cloud Processing

The processing to assign the labels to the objects in step 308 of the method 300 may be performed locally (e.g., within the store 14) or remotely. Local processing may be performed by the controller 110, and remote processing may be performed by the cloud computing system 120. Local processing and remote processing may each be advantageous in certain situations, so the controller 110 may switch between local processing and remote processing in response to one or more conditions. In other embodiments, the processing to assign the labels to the objects in step 308 may be performed as only local processing or only remote processing.

In some embodiments, the cloud computing system 120 is better suited to perform the processing of step 308 than the controller 110. The cloud computing system 120 may be able to perform the processing more quickly and/or more accurately than the controller 110. By way of example, the cloud computing system 120 may have access to more processing power than the controller 110. By way of another example, the cloud computing system 120 may utilize different processing techniques (e.g., different artificial intelligence or machine learning models) that are more effective than the processing techniques of the controller 110. The processing techniques used by the cloud computing system 120 may be generally more effective than the processing techniques of the controller 110 or may be more effective under certain conditions (e.g., rain, fog, snow, dust storms, low- or no-light conditions, etc.).

While the cloud computing system 120 may be better suited to perform the processing of step 308 than the controller 110, the cloud computing system 120 requires a network connection in order to communicate with the controller 110. In some circumstances, such a network connection may be unstable, preventing the transfer of image data from the controller 110 to the cloud computing system 120 and/or the transfer of a response from the cloud computing system 120 to the controller 110. By way of example, the store 14 may be located in a rural area where the available infrastructure provides a low-speed or intermittent Internet connection. By way of another example, an Internet connection for a store 14 may be interrupted due to storms or maintenance. In such circumstances, the vision system 200 can continue to operate when the cloud computing system 120 is unreachable or otherwise inaccessible or intermittently available.

In some embodiments, the controller 110 determines whether the processing of step 308 will be performed locally or remotely based on a status of the connection between the controller 110 and the cloud computing system 120. The controller 110 may monitor a bandwidth (e.g., a download speed, an upload speed, etc.) of the connection. When processing is required in step 308, the controller 110 may compare the measured bandwidth of the connection to a predetermined threshold bandwidth. If the measured bandwidth is above the threshold bandwidth, the controller 110 may provide the image data to the cloud computing system 120 for processing. If the measured bandwidth is below the threshold bandwidth, the controller 110 may perform the processing of step 308 locally.

In some embodiments, the controller 110 attempts to perform the processing of step 308 locally and requests remote processing if unsuccessful. The controller 110 may be sufficient to complete the processing of step 308 under beneficial conditions, but the controller 110 may be less accurate or successful under other conditions. By way of example, the controller 110 may quickly and accurately assign labels to objects when the image data is capture under clear and sunny conditions. However, the controller 110 may lose efficiency or accuracy under conditions that obscure the objects. Such conditions may include rain, fog, snow, dust storms, low- or no-light conditions (e.g., night), or other conditions. In some embodiments, the cloud computing system 120 is adapted to perform the processing of step 308 under these undesirable conditions.

When processing the image data to assign the labels, the controller 110 may assign a confidence score to each determined label. By way of example, a machine learning model used by the controller 110 may automatically assign such a label. A higher confidence score may indicate a higher likelihood that the assigned label will be accurate. The controller 110 may compare the confidence score to a predetermined threshold score. If the confidence scores for all of the labels are above the threshold score, the controller 110 may perform the processing of step 308 locally. If one or more of the confidence scores are below the threshold score, the controller 110 may provide the image data to the cloud computing system 120 for processing.

When the controller 110 determines that the processing of step 308 should be completed using local processing, the controller 110 performs the assignment of labels. The controller 110 may utilize the image data from step 306 and assign labels to any objects within the image data according to the various methods described herein. This local processing may be performed without requiring communication with the cloud computing system 120.

When the controller 110 determines that step 308 should be completed using remote processing, the controller 110 transfers the image data to the cloud computing system 120 for processing to assign the labels. The image data transferred may be the image data as cropped and anonymized in step 304 and step 306. The controller 110 may further reduce the resolution of the image data prior to transferring the image data. By transferring a cropped, low-resolution image, the vision system 200 may reduce the bandwidth required for the image data to reach the cloud computing system 120. Additionally, by anonymizing the image data (e.g., erasing faces and license plates) prior to the transfer, the vision system 200 may ensure that the privacy of customers and employees is maintained.

Along with the image data, the controller 110 may provide a request to the cloud computing system 120 indicating what information is desired. The request may indicate what types of labels are being requested, as well as a list of acceptable labels that would be accepted as outputs of the processing. By way of example, the request may indicate that a vehicle color is desired and include a list of acceptable vehicle colors (e.g., white, black, gray, red, etc.). By way of another example, the request may indicate that a vehicle type is desired and include a list of acceptable vehicle types (e.g., car, pickup, SUV, van, sports car, etc.). By way of another example, the request may indicate that a vehicle make and a vehicle model are desired.

By way of example, when processing the image shown in FIG. 10, the controller 110 may transfer the portion of the frame 430 that is included within the first bounding box 432 to the cloud computing system 120. Alternatively, the controller 110 may only transfer the portion of the frame 430 that is covered by the mask 440. Along with the image data, the controller 110 may provide a request indicating that the cloud computing system 120 should provide a vehicle type along with a list of acceptable vehicle types. The acceptable vehicle types may include “car,” “pickup,” “SUV,” “van,” and “sports car.” In response, the cloud computing system 120 may indicate that the vehicle type for the provided image is “pickup.”

By way of another example, when processing the image shown in FIG. 11, the controller 110 may transfer the image of FIG. 11 to the cloud computing system 120. As shown, the image of FIG. 11 has already been cropped an anonymized. Along with the image data, the controller 110 may provide a request to the cloud computing system 120. The request may include (a) a request for a vehicle type, (b) a list of acceptable vehicle types, (c) a request for vehicle color, and (d) a list of acceptable vehicle colors. The acceptable vehicle types may include “car,” “pickup,” “SUV,” “van,” and “sports car.” The acceptable vehicle colors may include “white,” “black,” “gray,” “red,” “blue,” “green,” “yellow,” “orange,” “purple,” and “brown.” In response, the cloud computing system 120 may indicate that the vehicle type for the provided image is “sedan”, and the vehicle color for the provided image is “red.”

FIG. 12 illustrates an image of another vehicle 402 that has been cropped and anonymized according to step 304 and step 306. The controller 110 may transfer the image of FIG. 12 along with a request to the cloud computing system 120. The request may include (a) a request for a vehicle type, (b) a list of acceptable vehicle types, (c) a request for vehicle color, (d) a list of acceptable vehicle colors, (e) a request for a vehicle make, and (f) a request for a vehicle model. The acceptable vehicle types may include “car,” “pickup,” “SUV,” “van,” and “sports car.” The acceptable vehicle colors may include “white,” “black,” “gray,” “red,” “blue,” “green,” “yellow,” “orange,” “purple,” and “brown.” In response, the cloud computing system 120 may indicate that the vehicle type for the provided image is “sports car”, the vehicle color for the provided image is “white,” the vehicle make for the provided image is “BMW,” and the vehicle model for the provided image is “2 Series Coupe.” When a label is requested without providing a list of acceptable labels, the cloud computing system 120 may automatically generate a label.

### 6. Zone Projection

Referring to FIGS. 1, 3, and 8, in step 310 of the method 300, the vision system 200 assigns a zone to each of the vehicles identified in step 306. When initially setting up the drive through system 10, an installer may define a series of zones at different positions within the field of view 132 of each camera 130. Each zone may represent a position that a vehicle 30 would occupy when progressing along the lane system 16. Based on which zone contains a given vehicle 30, the stage of progression through the drive through system 10 for the vehicle 30 may be determined. By way of example, a vehicle 30 present in a zone near the starting location 32 will likely not have completed an order, whereas a vehicle 30 present in a zone near the ending location 34 will likely have received their order and be prepared to exit the drive through system 10. Vehicles 30 that are not captured within any zones may be considered to be outside of the lane system 16, and accordingly may be ignored.

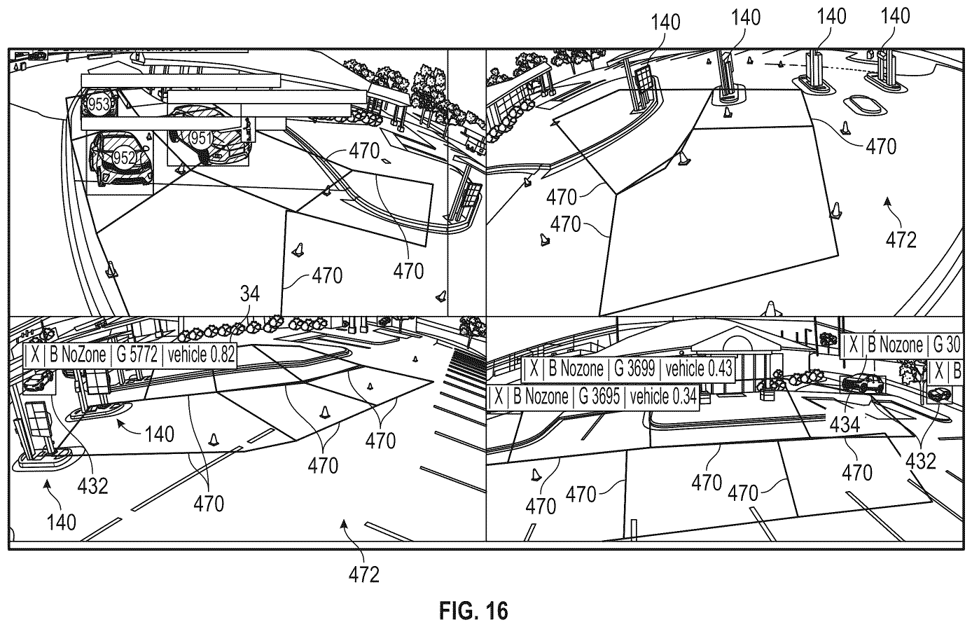

Referring to FIG. 8, the frame 430 includes a series of zones 470 within the field of view 132 of a camera 130 (e.g., the camera 130a of FIG. 1). As shown, the zones 470 include a first zone 470a, a second zone 470b, a third zone 470c, a fourth zone 470d, and a fifth zone 470e. The zones 470 are arranged along the lane system 16 and arranged sequentially from left to right in the order that a vehicle 30 (e.g., the vehicle 402) is expected to progress along the lane system 16. During a normal operation of the system 10, a vehicle 30 would be expected to pass through the first zone 470a, the second zone 470b, the third zone 470c, the fourth zone 470d, and the fifth zone 470e in sequence. As shown in FIG. 8, the frame 430 includes areas or image portions shown as out of bounds areas 472 that are outside of all of the zones 470. A vehicle 30 that is located within one of the out of bounds areas 472 (i.e., that is not positioned within any of the zones 470) may not be progressing along the lane system 16. FIG. 16 illustrates frames of image data showing other examples of zones 470 and bounds areas 472 within the system 10. Each of the frames within FIG. 16 may represent a different view 132 showing a different portion of the system 10. Accordingly, the vision system 200 may assign zones 470 within the entry lane 18, within the order lanes 20, within the pickup lane 22, within the one or more escape lanes 23, in association with (e.g., adjacent to) a drive through unit 26, and/or in association with a window 28.

As shown in FIG. 8, the out of bounds area 472 includes a series of parking spaces. In some embodiments, the vision system 200 assigns zones 470 to one or more parking spaces, such that the vision system 200 may identify vehicles 30 within parking spaces. The parking spaces my include angled parking, straight parking, street or parallel parking, and/or other parking arrangements.

One or more of the zones 470 may be assigned labels or flags based on their location along the lane system 16. Out of all of the zones 470 assigned to all of the cameras 130, the zone closest to the starting location 32 may be flagged as the store entering zone, and the zone closest to the ending location 34 may be flagged as the store exiting zone. A vehicle 30 within the store entering zone is likely to have just entered the drive through system 10. Similarly, a vehicle 30 within the store exiting zone is likely about to exit the drive through system 10. The first zone 470a shown in FIG. 8 may be flagged as the store entering zone.

The first zone 470 within a field of view 132 and the last zone with a field of view 132 may be flagged as a camera switch zone. Because the camera switch zones are positioned at the boundaries of the field of view 132 of a camera 130, the camera switch zones may represent the first zone 470 where a camera 130 is capable of detecting a vehicle (e.g., a camera entering zone) or the last zone 470 where a camera 130 s capable of detecting a vehicle 30 (e.g., a camera exiting zone). As shown in FIG. 7, the first zone 470a may be flagged as a camera switch zone where a vehicle 30 enters the frame 430 (e.g., a camera entering zone), and the fifth zone 470e may be flagged as a camera switch zone where a vehicle 30 exits the frame 430 (e.g., a camera exiting zone).

Referring to FIGS. 1 and 8, the fields of view 132 of some cameras 130 do not overlap. By way of example, a gap is provided between the field of view 132a and the field of view 132b. Accordingly, a vehicle 30 would exit the field of view 132a through a camera switch zone of the first camera 130a (e.g., the fifth zone 470e), remain undetected for a portion of the progression of the vehicle 30, then enter the field of view 132b through a camera switch zone of the second camera 130b. The fields of view of other cameras 130 do overlap. By way of example, the field of view 132b overlaps the field of view 132c, such that a vehicle 30 may simultaneously be present within a zone of the second camera 130b and a zone of the third camera 130c.

In step 310 of the method 300, the controller 110 may analyze the image data provided by each camera 130 and attempt to assign a zone to each of the vehicles 30 identified within a given frame of image data. During the initial setup of the vision system 200, the zones 470 may be defined within the field of view 132 of each camera 130. Each zone 470 may have a predetermined shape, size, and location (e.g., corresponding to a predetermined subset of pixels) within the field of view 132. In some embodiments, each zone 470 is applied as an image mask (e.g., a zone mask) that identifies which pixels of each captured frame corresponding to the zone 470.

Referring to FIG. 9, for each vehicle 30 identified in a given image in step 306, the controller 110 may compare the identified boundaries of the vehicle 402 (e.g., the mask 440) with the boundaries of each zone 470. The controller 110 may determine which zone 470 contains the largest portion of the vehicle 402. The controller 110 may then determine if the portion of the vehicle 402 represents a large enough portion of the vehicle 402 for the vehicle 402 to be considered to occupy that zone 470.

By way of example, the controller 110 may multiply the mask 440 for the vehicle 402 with the zone mask for each zone 470 (e.g., by representing the masks as matrices). Each multiplication may result in a Boolean mask, and the controller 110 may reduce each Boolean mask to a single representative number by summing all of the pixels of the Boolean mask. The controller 110 may compare the representative numbers to determine the largest one, then compare this representative number to a predetermined threshold. If the largest representative number is larger than a predetermined threshold, the vehicle 402 is determined to occupy the zone 470 associated with that representative number. If the largest representative number is smaller than the predetermined threshold, the vehicle 402 is determined to be outside of the zones 470 (e.g., within one of the out of bounds areas 472). Additionally or alternatively, the controller 110 may apply a zone mask to an out of bounds area 472 and positively determine that a vehicle 402 is in the out of bounds area 472 based on the mask 440 for the vehicle 402 and the zone mask of the out of bounds area 472.

This process is represented visually in FIG. 9. The mask 440 of the vehicle 402 is partially contained within the third zone 470c and the fourth zone 470d. A first number of pixels of the mask 440 that overlap the zone mask of the third zone 470c is greater than a second number of pixels of the mask 440 that overlap the zone mask of the fourth zone 470d. Accordingly, the third zone 470c is the most likely zone 470 for the vehicle 402 to occupy. The pixels of the mask 440 that are contained within the third zone 470c represent the majority of the pixels of the mask 440 (e.g., over a threshold percentage of the total pixels). Accordingly, the vehicle 402 is present within the third zone 470c, not an out of bounds area 472.

This process may be repeated for each identified vehicle 30 and for each camera 130 until all of the identified vehicles 30 are assigned a zone 470 or determined to be present within an out of bounds area 472. The vision system 200 may cease tracking vehicles 30 that are determined to be present within an out of bounds area 472. Alternatively, the vision system 200 may temporarily classify such a vehicle 30 as being out of bounds, but continue tracking the vehicles 30 to determine whether the vehicle 30 has entered a zone 470.

In some embodiments, the boundaries of the zones 470 are utilized before performing motion detection in step 304. In some embodiments, the controller 110 ignores motion of objects outside of the zones 470. By way of example, the controller 110 may automatically crop the image to include only the pixels within the zone masks (e.g., to exclude the pixels within the out of bounds areas 472). This may further reduce the processing power required to perform the method 300.

### 7. Employee Association

In step 312 of the method 300, the vision system 200 associates one or more of the employees 50 identified in step 306 with identified vehicles 30. Such an association may indicate that the employee 50 is assigned to or otherwise assisting a customer within a vehicle 30. The association may be based on the proximity and/or orientation of the employee 50 relative to the vehicle 30. In other embodiments, step 312 is omitted from the method 300.

In some embodiments where the vision system 200 assigns a human label in step 308, the vision system 200 determines whether or not perform step 312 based on the human label. By way of example, the vision system 200 may determine that step 312 should be skipped in response to the human label indicating that the human is a non-employee. By way of another example, the vision system 200 may determine that step 312 should be skipped in response to the human label indicating that the human is a food runner. In some such embodiments, it may not be necessary to associate a food runner with a vehicle 30, as the food runner may not take food orders. In other embodiments, the step 312 is performed for all detected humans.

During step 306 of the method 300, the controller 110 may determine a position and an orientation for each employee 50 and each vehicle 30. In step 312, the controller 110 may compare the positions of the employees 50 and the vehicles 30 to identify an employee 50 that is in proximity to a vehicle 30 (e.g., within a predetermined area relative to the vehicle 30). The controller 110 may compare the orientation of the employee 50 with the position of the vehicle 30 to determine whether the employee is facing toward the vehicle 30 (e.g., the field of view of the employee 50 overlaps the vehicle 30).

The controller 110 determines whether to associate the employee 50 with the vehicle 30 based on (a) whether the employee 50 is within the predetermined area relative to the vehicle 30 and/or (b) whether the employee 50 is facing toward the vehicle 30. In some embodiments, the controller 110 associates the employee 50 with the vehicle 30 in response to a determination that the employee 50 is within the predetermined area relative to the vehicle 30. In some embodiments, the controller 110 associates the employee 50 with the vehicle in response to a determination that the employee 50 is both within the predetermined area relative to the vehicle 30 and facing toward the vehicle 30. In some embodiments, the controller 110 requires that the conditions indicative of the association (e.g., the proximity and/or the orientation of the employee 50) are maintained for a least a threshold period of time before recording the association. The controller 110 may remove the association between the employee 50 and the vehicle 30 in response to the employee 50 moving away from the vehicle 30 (e.g., outside of the predetermined area) or turning away from the vehicle 30.

The predetermined area relative to the vehicle 30 may have a predetermined shape, size, and position relative to the vehicle 30. In some embodiments, the predetermined area is a range of positions extending around the entire vehicle 30 (e.g., a ring around the vehicle 30), such that the predetermined area includes all positions within a threshold distance of the vehicle 30. In some embodiments, the predetermined area is a subset of positions where the employee 50 is likely to be located when interacting with a customer within the vehicle 30. By way of example, the predetermined area may be a range of positions near a driver's side window of the vehicle 30 (e.g., near a front-left quadrant of the vehicle 30).

The employee 50 may typically interact with a customer who is operating the vehicle 30 (i.e., a driver), and most vehicles within a given area (e.g., state, country, etc.) may position the driver in a common location across most vehicles. By placing the predetermined area near the driver's side window of the vehicle 30, the vision system 200 may avoid falsely associating the employee 50 with the vehicle 30 when the employee 50 is positioned nearby the vehicle 30 but in an area where the employee 50 would not typically interact with the driver. By way of example, when the employee 50 is positioned between two vehicles 30 (e.g., between two order lanes 20), the vision system 200 is more likely to correctly identify the vehicle 30 that the employee 50 is actually servicing. If the vision system 200 were to only take into account the distance between the employee 50 and the vehicles 30 instead of the distance and the relative position, the vision system 200 may associate one employee 50 with two vehicles 30, even though the employee 50 is only interacting with one of the vehicles 30.

FIG. 10 illustrates an example of step 312 of the method 300. As shown, the controller 110 determined a distance between the employee 406 and the vehicle 402. This distance is represented using a distance indicator 480, which shows the distance as 8.9 feet. Additionally, the controller 110 determined a direction of a field of view of the employee 406, which is shown as arrow 482. In one embodiment, the threshold distance (e.g., a maximum distance) required for an employee 50 to be in proximity to a vehicle 30 is 10 feet. In this embodiment, the employee 406 would be considered in proximity to the vehicle 30, because the measured 8.9 feet is less than the threshold distance. Additionally, the arrow 482 intersects the vehicle 402. Accordingly, the employee 406 would be in condition to be associated with the vehicle 402.

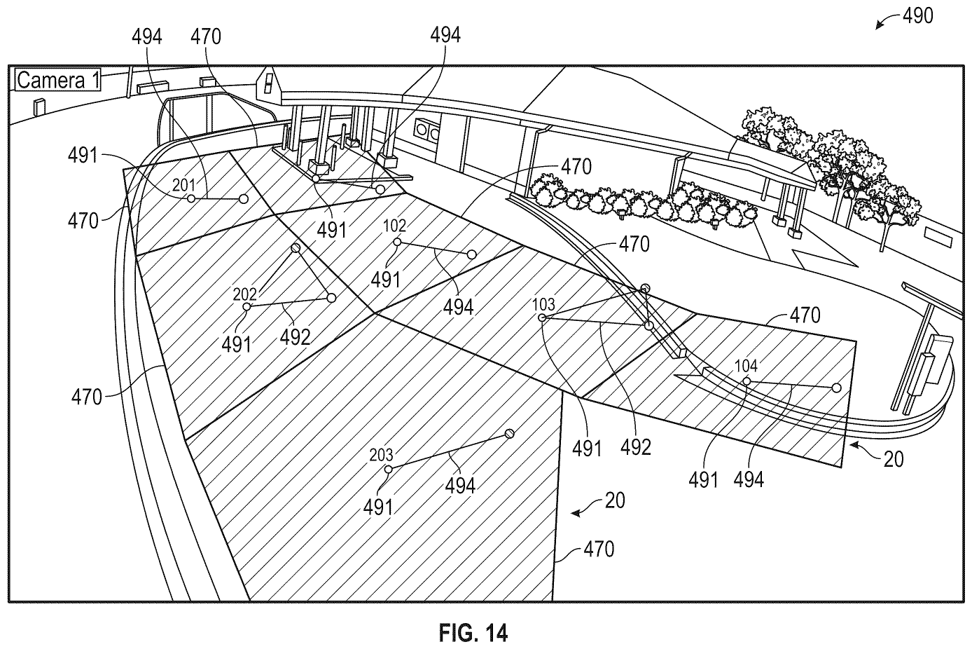

FIG. 14 is a frame 490 of image data captured by a camera 130. FIG. 14 illustrates another example of step 312 of the method 300. As shown, the frame 490 captures a series of zones 470 belonging to a pair of adjacent order lanes 20. The vision system 200 assigns a predetermined area for associating employees 50 with vehicles 30 to vehicle 30 within each of the zones 470. If an employee 50 enters the predetermined area, the employee 50 is associated with a vehicle 30 that is determined to be within the zone 470.

As shown in FIG. 14, each of the predetermined areas includes a starting point or vehicle point, shown as on-vehicle indicator 491. The on-vehicle indicator 491 may be placed (e.g., manually when setting up the vision system 200) in or near a location where the driver of a vehicle 30 is expected to be located when the vehicle 30 is positioned within the zones 470. The predetermined area then extends from the on-vehicle indicator 491 away from the vehicle 30.

The predetermined areas may have a variety of different shapes. In some embodiments, the employee 50 is associated with the vehicle 30 as long as some portion of the predetermined area intersects or overlaps with some portion of the employee 50 (e.g., a portion of the second bounding box 436). FIG. 14 illustrates a series of triangular or conical predetermined areas, shown as triangular areas 492. The triangular areas 492 gradually increase in width as the triangular areas 492 extend away from the on-vehicle indicator 491, capturing employee 50 within a range of locations that has a greater tolerance as the employee 50 is positioned further from the on-vehicle indicator 491. FIG. 14 further illustrates a series of linear predetermined areas, shown as linear areas 494. The linear areas 494 have a constant width as the linear areas 494 extend away from the on-vehicle indicator 491. The triangular areas 492 and the linear areas 494 each extend a threshold distance from the corresponding on-vehicle indicator 491, such that the triangular areas 492 and the linear areas 494 do not capture employees 50 that are beyond the threshold distance.

In some embodiments, the positions of the predetermined areas are fixed relative to the zones 470. By way of example, the predetermined areas may be static and set when initially setting up the vision system 200. In such embodiments, the on-vehicle indicator 491, the triangular areas 492, and/or the linear areas 494 may have a predetermined, fixed location relative to the zones 470. In other embodiments, the predetermined areas are dynamic and move with the vehicle 30. In such an embodiment, the vision system 200 may assign and position the on-vehicle indicator 491, the triangular areas 492, and/or the linear areas 494 based on the position of the first bounding box 432 around each vehicle 30. By way of example, the vision system 200 may place the on-vehicle indicator 491 in the center of the first bounding box 432 and position a triangular area 492 or a linear area 494 extending in a predetermined direction away from the on-vehicle indicator 491.

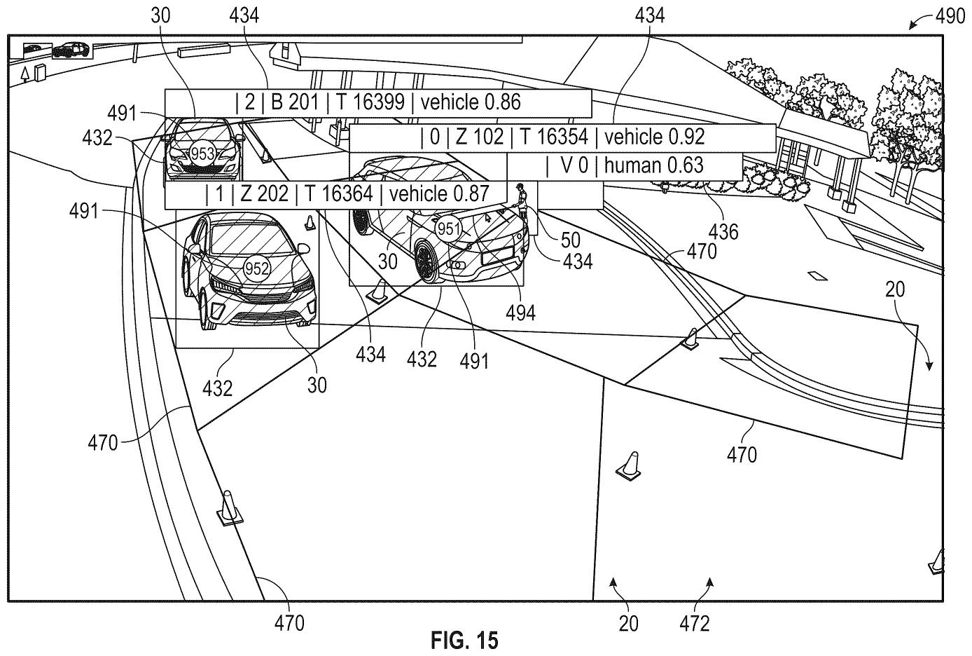

FIG. 15 illustrates an example of the frame 490 populated with a series of vehicles 30 and an employee 50. An on-vehicle indicator 491 is assigned to each of the vehicles 30 based on the positions of the first bounding boxes 432. As shown, the vision system 200 has associated the employee 50 with one of the vehicles 30 because the second bounding box 436 corresponding to the employee 50 overlaps the linear area 494 corresponding to the vehicle 30.

The association between employees 50 and vehicles 30 may be used by various processes of the control system 100. By way of example, as shown in FIG. 1, the employee 50a and the employee 50b may each take orders from customers within vehicles 30. The employee 50a and the employee 50b each utilize an order taking station 140 to record these orders and enter the orders into the control system 100. As shown, the employee 50a is within the field of view 132c of the third camera 130c, and the employee 50b is within the field of view 132b of the second camera 130b. The controller 110 may utilize image data from the second camera 130b and the third camera 130c to associate the employee 50a and the employee 50b with any nearby vehicles 30. When taking orders, the employees 50 may typically be in condition for association with the vehicle 30 where the order is being taken (e.g., facing the vehicle 30 and in proximity to the vehicle 30). The controller 110 may automatically assign any orders received by an order taking station 140 with the vehicle 30 that was associated with the corresponding employee 50 when the order was received. In this way, the vision system 200 may automatically assign orders to vehicles 30 without requiring a manual input by the employee 50 to identify the vehicle 30.

### 8. Single Camera Object Tracking

In step 314 of the method 300, the vision system 200 updates a database of tracked objects for each camera 130. For each processed frame of image data, the identified objects may have a given position. In between frames, the objects may shift and have updated positions. While steps 302-312 may provide the positions of identified objects for a given frame of image data, in some embodiments, these positions can be related to the positions determined for previous frames of image data. By way of example, a vehicle 30 may be determined to be located within a first zone 470 in a first frame of image data. In a second frame of image data, this vehicle 30 may have moved from the first zone 470 to a second zone 470. In step 314, the controller 110 may determine that the vehicles 30 detected in these two frames are actually the same vehicle 30, and that that vehicle 30 has moved between the two zones 470.

In this way, multiple actions happening at different times may be associated with the same vehicle 30. By way of example, an order may be taken for a given vehicle 30 at a first time while the vehicle 30 is in a first position. The customer may then provide payment for the order at a second time while the vehicle 30 is in a second position. The order may then be fulfilled and provided to the vehicle 30 at a third time while the vehicle 30 is in a third position. By tracking the movement of the vehicle 30, all three of these actions may be associated with the same vehicle 30, even though they occur at different times and in different positions.

Certain algorithms for tracking objects assume that the object will only experience a relatively small amount of movement between consecutive frames of image data. While the drive through system 10 primarily operates with vehicles 30 moving at slow speeds, experimentation has identified several exceptions that prevent such algorithms from operating accurately with the drive through system 10. By way of example, vehicles 30 may travel at higher speeds when the lane system 16 is empty of other vehicles 30. By way of another example, a vehicle 30 may appear to move a significant distance between consecutive frames when nearby a camera 130. By way of another example, the vision system 200 may experience delays due to processing power limitations or camera latency. Accordingly, exemplary embodiments of the present disclosure can employ techniques for robust tracking of objects across consecutive frames, even if the objects move relatively quickly.

To track the vehicles 30, the controller 110 prepares, updates, and stores (e.g., in the memory 114) an object tracking database 500. The object tracking database 500 contains a unique identifier for each identified object, the determined position of each object (e.g., a zone zones 470, an out of bounds area 472, etc.), and a corresponding time stamp for the detection of the object. The use of the object tracking database 500 to track the positions of vehicles 30 will be discussed herein. However, the object tracking database 500 may additionally or alternatively contain data for tracking humans (e.g., employees 50).

Each time a frame of image data is processed, every identified vehicle 30 is either matched to an existing vehicle identifier within the object tracking database 500, or a new vehicle identifier is created. When the identified vehicle 30 is matched to an existing vehicle identifier, this indicates that the vehicle 30 has been previously detected, but may have changed position. When the identified vehicle 30 requires creation of a new vehicle identifier, this indicates that the identified vehicle 30 has not been previously detected by that camera 130.

Once an identified vehicle 30 is matched to a vehicle identifier within the object tracking database 500, the current position and a corresponding time stamp are added to the object tracking database 500 for that vehicle identifier. By way of example, the current position may be an indication of which zone 470 currently contains the vehicle 30. The object tracking database 500 may accumulate position and time stamp pairs for each vehicle identifier, such that the movement of the vehicle 30 over time is recorded.

In some situations, a vehicle identifier may go unused after all of the identified vehicles 30 have been assigned. By way of example, the controller 110 may create a vehicle identifier for a red pickup truck that was identified at a first time. In step 314, all of the identified vehicles 30 for a new frame of image data may be assigned to vehicle identifiers within the object tracking database 500. However, if the red pickup truck is not identified in this new frame, the vehicle identifier for the red pickup truck may go unassigned. This may be an indication that the red pickup truck has left the field of view 132 of the camera 130. Accordingly, the controller 110 may delete the vehicle identifier for the red pickup truck from the object tracking database 500 in response to the vehicle identifier going unassigned. However, the controller 110 may require the vehicle identifier to go unassigned multiple times (e.g., for at least a threshold number of frames, for at least a threshold period of time, etc.) before deleting the vehicle identifier. This tolerance may avoid mistakenly deleting the vehicle identifier due to a missed detection or image corruption.

To match the identified vehicles 30 from the frame of the image data (i.e., the input vehicle) with the vehicles in the object tracking database 500 (i.e., the database vehicles), the controller 110 utilizes an algorithm that leverages one or more score functions. Each input vehicle is compared against all of the database vehicles, generating a score for each pair. A database vehicle is considered a matching candidate for an input vehicle if the corresponding score is above a threshold score. Similarly, each database vehicle is compared against all of the input vehicles, generating a score for each pair. An input vehicle is considered a matching candidate for a database vehicle if the corresponding score is above the threshold score.

When both (a) an input vehicle has only a single database vehicle as a matching candidate and (b) that database vehicle has only the input vehicle as a matching candidate, the controller 110 considers this to be a perfect match. The object tracking database 500 is then updated to associate the identified vehicle 30 with the corresponding vehicle identifier in the object tracking database 500. This is repeated until no other perfect matches are available.

If there is still at least one input vehicle and at least one database vehicle that have not been matched, the controller 110 may repeat this process using a different score function. The controller 110 may begin using a score function having a relatively high confidence and switch to score functions having progressively lower confidences as the process is repeated. This algorithm may runs iteratively until there are no more input vehicles or no more database vehicles left to be matched.

The first score function (e.g., the score function having the highest confidence) may be based on the location of the input vehicle, the last known location of the database vehicle, and an expected location of the database vehicle based on the expected flow of traffic through the lane system 16. By way of example, in the embodiment of FIG. 9, the vehicle 402 may previously have been identified as occupying the second zone 470b, and the controller 110 may identify the vehicle 402 as currently occupying the third zone 470c. Because traffic flows left to right, the controller 110 may expect the vehicle 402 to move from the second zone 470b to the third zone 470c. The first score function may utilize an Intersection Over Union metric based on the location of the input vehicle, the last known location of the database vehicle, and the expected location of the database vehicle. The controller 110 may iteratively run the first score function with a threshold score that gradually decreases.

As a second score function (e.g., a score function having a lower confidence than the first score function), the controller 110 may use a zone score. The zone score may be a Boolean function that is true when both the input vehicle and the output vehicle are detected within the same or consecutive zones. As a third score function (e.g., a score function having a lower confidence than the second score function, the controller 110 may use a size score. The size score may be based on a change in size of the input vehicle and the output vehicle. As a fourth score function (e.g., a score function having a lower confidence than the third score function), the controller 110 may use a mixed score. The mixed score may be calculated by summing the zone score with the Intersection Over Union score.

### 9. Vehicle Tracking

In step 316 of the method 300, the controller 110 performs vehicle tracking across multiple cameras 130. Steps 302-314 of the method 300 may each be performed separately for each camera 130. By way of example, the controller 110 may form separate prediction pipelines for each camera 130. Each prediction pipeline may receive the stream of image data from the camera 130 as an input and output the data that is stored within the object tracking database 500.

By using multiple cameras 130, the vehicle tracking may be performed across an area wider than the field of view 132 of a single camera 130. However, this means that the object tracking database 500 includes data from multiple different cameras 130. Because the image data from each camera 130 is analyzed as part of a separate prediction pipeline, it may be necessary to indicate which vehicle identifiers correspond to which cameras 130. To accomplish this, the vehicle identifiers of the object tracking database 500 may identify both a vehicle and a camera 130 where the vehicle is detected (e.g., a zone 470, an out of bounds area 472, etc.). In some embodiments, the object tracking database 500 stores the vehicle identifiers as Camera Tracker Identifiers (CTIDs). A CTID may have the format (Camera_ID, Tracking_ID), such that the CTID identifies both the camera 130 that captured the image (i.e., the Camera_ID) and the vehicle 30 identified by the camera 130 (i.e., the Tracking_ID).

Because the streams of image data from each camera 130 are analyzed separately, the CTIDs do not necessarily refer to unique vehicles 30. By way of example, in the configuration of FIG. 1 where the field of view 132b and the field of view 132c overlap one another, a vehicle 30 may be simultaneously present in both fields of view 132. Accordingly, even though only one vehicle 30 is detected, the controller 110 may generate two different CTIDs for the vehicle 30 while the vehicle 30 is detected by the camera 130b and the camera 130c.

In order for the object tracking database 500 to provide a single source of truth regarding the locations of vehicles 30 in the system 10, the controller 110 may unify all of the CTIDs to generate a single set of vehicle IDs (VIDs) within a vehicle tracking database 510 (e.g., stored within the memory 114). Unlike the CTIDs where multiple CTIDs may correspond to a given vehicle 30, each VID may be unique to each vehicle 30, regardless of how many of the cameras 130 have viewed the vehicle 30. The vehicle tracking database 510 may include a dictionary indicating which CTIDs correspond to each VID. If multiple CTIDs correspond to a single VID, this may be an indication that the vehicle 30 has been detected by multiple cameras 130.

After new information is generated as part of a prediction pipeline and stored in the object tracking database 500, the controller 110 prepares this information for storage in the vehicle tracking database 510. If the CTID for the new information is already mapped to a VID, then that vehicle 30 has already been detected by the same camera before. Accordingly, the controller 110 may add the information to the vehicle tracking database 510 in association with that VID without further processing.

If the CTID for the new information indicates that a vehicle 30 is in a store entrance zone (e.g., the closest zone 470 to the starting location 32), the vehicle 30 may have just entered the lane system 16. If the CTID is not yet mapped to a VID and the CTID is within the store entrance zone, the controller 110 may generate a new VID within the vehicle tracking database 510 and map the CTID to the new VID.

If the CTID for the new information indicates that the vehicle 30 is in a store exiting zone (e.g., the closest zone 470 to the ending location 34), the vehicle 30 may be about to exit the lane system 16. When the CTID indicates that the vehicle 30 is no longer detected after exiting the store exiting zone, the vehicle 30 may be determined to have left the lane system 16. Accordingly, the controller 110 may remove the corresponding VID from the vehicle tracking database 510.

When the vehicle 30 is transitioning between the fields of view 132 of different cameras 130, the vehicle 30 may exit the field of view 132 of a first camera 130 through a camera exiting zone and enter a field of view 132 of a second camera 130 through a camera entering zone. The timing between when the vehicle 30 exits the field of view 132 of the first camera 130 and when the vehicle 30 enters the field of view 132 of the second camera 130 may be based on whether the fields of view 132 overlap one another.

When a CTID indicates that a vehicle 30 has entered a camera exiting zone, the controller 110 may enter the VID for the corresponding vehicle 30 into a zone exiting queue, indicating that the vehicle 30 is about to exit the field of view 132 of the camera 130. After the vehicle 30 leaves the field of view 132 of the camera 130, the controller 110 may remove the corresponding CTID from the vehicle 30 tracking database 510 (e.g., to save memory). This CTID may no longer be useful after the vehicle 30 leaves the field of view 132 of a camera 130, as the vehicle 30 will no longer be tracked by the camera 130. An example of a camera exiting zone is the fifth zone 470e of FIG. 8. Because the fifth zone 470e is positioned along the right boundary of the field of view 132 and traffic is expected to move left to right, the vehicle 402 may exit the field of view 132 immediately after exiting the fifth zone 470e.

When a vehicle 30 first enters the field of view 132 of a camera 130, the vehicle 30 may enter through a camera entering zone, and the CTID for the vehicle 30 may not yet have been mapped to a VID. If the CTID for a vehicle 30 is present within a camera entrance zone and the CTID for the vehicle 30 has not been mapped to a VID in the vehicle tracking database 510, the controller 110 may enter the CTID into a zone entering queue. The zone entering queue may indicate that the vehicle 30 has recently entered the field of view 132 of the camera 130 corresponding to the CTID.

The controller 110 may use the zone exiting queue and the zone entering queue to determine the corresponding VID that should be used when a vehicle 30 transitions between different cameras 130. The controller 110 may routinely (e.g., once per second) search or compare the zone entering queue and the zone exiting queue to see if a matching vehicle 30 is contained in both queues. When a match is detected, the CTID from the zone entering queue is assigned to the VID of the vehicle 30 from the zone exiting queue. The matching vehicle 30 may then be removed from both queues. This process may provide a robust process for transitioning a detected vehicle 30 between multiple cameras that is capable of accurately tracking vehicles 30 even if two cameras 130 are not in sync with one another.

At the conclusion of step 316 of the method 300, the vision system 200 has used image data from a series of cameras 130 to identify employees 50 and vehicles 30 throughout the drive through system 10. The vision system 200 has assigned labels to each of the vehicles 30 that identify characteristics of each vehicle 30 (e.g., vehicle type, vehicle color, etc.). The vision system 200 has generated a vehicle tracking database 510 that provides the position of each vehicle 30 within the lane system 16. The vision system 200 has associated employees 50 with corresponding vehicles 30 that the employees 50 are assisting. The information determined using the method 300 may be used to other processes performed by the control system 100, such as order fulfillment and tracking performance metrics of the drive through system 10.

### Ordering and Fulfillment Process

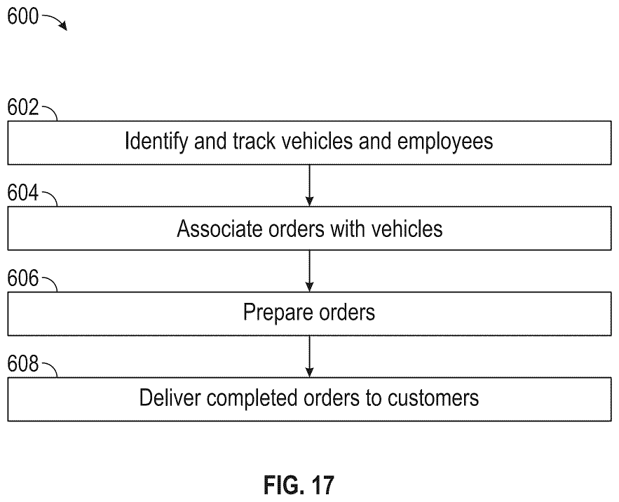

Referring to FIGS. 1-3 and 17, the system 10 may be used to complete an ordering and fulfillment process, shown as method 600, using the vision system 200 to support an order-taking workflow by detecting and tracking vehicles 30. The method 600 may begin when the vehicle 30 enters the system 10 and end when the vehicle 30 has exited the system 10. The method 600 may ensure that the order of the customer associated with the vehicle 30 is taken, prepared, and served to the customer as the vehicle 30 moves through the system 10. Throughout the method 600, the controller 110 may record timestamps for certain events to facilitate quantifying the performance of the system 10 and the employees 50.

In step 602 of the method 600, the vehicles 30 and/or employees 50 are identified and tracked. By way of example, the vision system 200 may identify one or more vehicles 30 and/or one or more employees 50. The method 600 may begin when a vehicle 30 enters the system 10 (e.g., through the starting location 32) and is viewed by one or more of the cameras 130. The vision system 200 utilizes image data from the cameras 130 to perform the method 300. The vision system 200 may assign a vehicle label (e.g., including a vehicle type and color) and a vehicle ID to the vehicle 30 and generate an anonymized image of the vehicle 30. The vision system 200 may further determine which zone 470 contains the vehicle 30. The vision system 200 may identify and locate any employees 50 visible within the image data from the cameras 130. As the vehicle 30 progresses through the system 10 (e.g., from the entry lane 18 to the order lanes 20 to the pickup lane 22 and/or the one or more escape lanes 23), the vision system 200 may continuously track the positions of the vehicle 30 and the employees 50 and associate or disassociate one or more employees 50 with the vehicle 30 as appropriate.

In step 604 of the method 600, one or more orders are associated with one or more vehicles 30. Orders may be taken (e.g., order data may be received) from a variety of different sources. The order data is then recorded in the order database 150 in association with the corresponding vehicle 30. The controller 110 may require confirmation of payment for the order before completing step 604.

In some embodiments, the order is taken by an employee 50 that approaches the vehicle 30 (e.g., a line buster). The employee 50 may be carrying a portable order taking station 140 that the vision system 200 has previously assigned to that employee 50 (e.g., manually assigned at the beginning of that employee's shift). The controller 110 may automatically detect that the employee 50 is in position to be associated with the vehicle 30 and, in response, associate the order received by the order taking station 140 with the corresponding vehicle 30. The customer may communicate verbally or visually to the employee 50 what items should be ordered, and the employee 50 may enter the order through the order taking station 140. The employee 50 may also take payment for the order through the order taking station 140.

In some embodiments, the order is communicated through a drive through unit 26. A vehicle 30 may move along an order lane 20 to the drive through unit 26, and the vision system 200 may determine that the vehicle 30 has entered a zone 470 associated with that drive through unit 26. The drive through unit 26 may facilitate verbal communication between the customer and an employee 50 (e.g., the employee 50c) through a series of microphones and speakers. The customer may communicate verbally to the employee 50 what items should be ordered, and the employee 50 may enter the order through the order taking station 140. The vision system 200 may automatically associate the order with the vehicle 30 determined to be in the zone 470 of the drive through unit 26. Payment may be taken by an employee 50 once the vehicle 30 reaches one of the windows 28 (e.g., through an order taking station 140).

In some embodiments, the order is a mobile order entered by the customer through a user device 152. The mobile order may be placed at any time, before or after arrival of the vehicle 30 within the system 10, and stored in the order database 150. Through the user device 152, the customer may indicate which items should be ordered along with a piece of identifying information (e.g., a name, a phone number, etc.). When the vehicle 30 arrives within the system 10, an employee 50 may approach the vehicle 30 to take the customer's order directly or may take the customer's order through a drive through unit 26. Instead of outlining the order in detail, the customer may simply indicate that they placed a mobile order and provide the piece of identifying information. The employee 50 may review a list of the pending mobile orders that have not yet been fulfilled through the order taking station 140 and select the mobile order corresponding to the provided identifying information. The controller 110 may automatically associate the order with the vehicle 30 associated with the employee 50 that took the order. The controller 110 may then remove the order from the list of pending mobile orders that have not yet been fulfilled and initiate fulfillment of the order. The customer may provide payment through the user device 152 or through an employee 50.

Alternatively, instead of checking in a mobile order with an employee, the customer may check in a mobile order directly though the drive through unit 26. By way of example, the user device 152 of the customer may provide a unique identifier that identifies the mobile order, and the drive through unit 26 may interact directly with the user device 152 to retrieve the unique identifier and determine which mobile order should be associated with the vehicle 30. By way of example, when a mobile order is generated, the cloud computing system 120 may generate a barcode (e.g., a one-dimensional barcode, a two-dimensional barcode, etc.), order number, or other unique identifier that his passed to both the controller 110 and the user device 152. The user device 152 may communicate the unique identifier to the drive through drive through unit 26 (e.g., visually through a screen, wirelessly through near-field communication, etc.), and the controller 110 may use the unique identifier to select the corresponding order.

Multiple orders may be associated with a single vehicle 30. By way of example, multiple people within a vehicle 30 may make separate mobile orders, such that all of the orders may be delivered to the same vehicle 10. By way of another example, a customer may make a mobile order and subsequently decide to supplement that order with another order made in person.

In step 606 of the method 600, the orders are prepared. The controller 110 may provide instructions to one or more employees 50 within the kitchen 42 to prepare the items of the orders. The controller 110 may provide instructions to the employees 50 through one or more order taking stations 140 positioned within the kitchen 42. The order taking stations 140 may indicate various information that facilitates preparation of the correct orders, such as a type and quantity of items within the order, revisions to the items (e.g., removal or addition of ingredients, which items should be grouped together, or other information. The order taking stations 140 may receive information regarding the preparation of the orders. This information may be provided manually by an employee 50 or automatically recorded using one or more sensors (e.g., cameras within a kitchen). The information may include indications of which items are in progress, which items have been prepared, when the completed order has been added to a staging area for delivery to a customer, whether the completed order has been removed from the staging area, and/or other information.

In step 608 of the method 600, the completed orders are delivered to the customers. Specifically, the completed orders containing all of the desired items are delivered to the corresponding vehicles 30. The controller 110 may track which orders are ready along with the positions of the vehicle 30. When an order is ready, the controller 110 may notify or instruct an employee 50 (e.g., through an order taking station 140) of which order should be delivered and which vehicle 30 it should be delivered to. The controller 110 may provide such an instruction in response to the vehicle 30 entering a particular zone 470 (e.g., a zone adjacent a window 28, a zone within a pickup lane 22, etc.). The employee 50 may deliver the order to the vehicle 30 through a windows 28. Additionally or alternatively, an employee 50 (e.g., a food runner) may exit the store 14 and deliver the completed order to the vehicle 30.

Once the order has been delivered, the vehicle 30 may exit the system 10 (e.g., through the ending location 34), and tracking of the vehicle 30 may cease. The vehicle 30 may exit through the pickup lane 22 or the one or more escape lanes 23. For example, the one or more escape lanes 23 may be used if a vehicle 30 receives their order before another vehicle 30 that is ahead in line. In some circumstances, a vehicle 30 may leave the system 10 before collecting their order. If the vision system 200 determines that the vehicle 30 exits after placing an order but before collecting the order, the controller 110 may cancel preparation of that order.

### Timestamps and Performance Metrics

Throughout execution of the method 600, the controller 110 may record timestamps indicating when various actions, milestones, or events have occurred. These timestamps may associated with particular vehicles, such that the experience of each vehicle 30 may be quantified and compared. These timestamps may then be used to generate performance metrics that quantity the performance of the individual employees 50 and the system 10 as a whole. These performance metrics may be monitored over time and/or compared across multiple locations (e.g., owned by the same individual or group, managed by the same individual or group, within the same region, etc.) to determine relative performance.

The controller 110 may record various timestamps associated with movement of a particular vehicle 30. By way of example, the controller 110 may record timestamps when the vehicle 30 arrives within the system 10, when the vehicle 30 is approached by (e.g., greeted by, associated with by the vision system 200, etc.) an employee 50 (e.g., a line buster), when the employee 50 begins moving away from the employee 50, when the vehicle 30 arrives at a drive through unit 26, when the vehicle 30 departs from the drive through unit 26, when the vehicle 30 arrives at a window 28 (e.g., a payment window where payment is provided or a pick-up window where an order is retrieved), when the vehicle 30 departs from the window 28, and/or other timestamps.

The controller 110 may record various timestamps associated with fulfillment of a particular order. By way of example, the controller 110 may record timestamps when an order is created or otherwise entered into the order database 150, when the order has been sent to the kitchen 42 for preparation, when the order has been paid, when the order has been prepared and is ready to be delivered, when the order is delivered to the customer at a window 28, when an employee 50 (e.g., a food runner) leaves to deliver food to a vehicle 30, when the employee 50 delivers the food to the vehicle 30, when the employee 50 returns from delivering food to the vehicle 30, and/or other timestamps.

The controller 110 may record various timestamps associated with preparation of an order within the kitchen 42. The timestamps may apply to the entire order or to individual items within an order. By way of example, the controller 110 may record timestamps when the order has been sent to the kitchen 42 for preparation, when the order has been claimed by an employee 50 to begin preparation, when preparation has begun, when preparation has concluded, when the order has been bagged, when the order is ready for delivery to the customer, and/or other timestamps.

The controller 110 may calculate various performance metrics that can be useful to inform decision-making to improve the customer experience and increase efficiency. The performance metrics may include the time spent in each stage of service, such as how long a vehicle 30 has been waiting in a particular location or how long an employee 50 is engaged in a specific task. In some embodiments, the controller 110 calculates a total time spent in the drive through by a particular vehicle 30 based on the timestamp for the arrival of the vehicle 30 and the timestamp for the departure of the vehicle 30. The controller 110 may calculate an average total time spent based on the average of the total time spent calculations for multiple vehicles at a given store 14.

In some embodiments, the controller 110 calculates a time spent ordering with an employee 50 (e.g., line buster) by a particular vehicle 30 based on the timestamp for the employee 50 approaching the vehicle 30 and the timestamp for the vehicle 30 moving away from the employee 50. The controller 110 may calculate an average time spent ordering with an employee 50 based on the average of the total time spent ordering with an employee 60 calculations for multiple vehicles 30 at a given store 14.

In some embodiments, the controller 110 calculates an idle time for an employee 50 (e.g., line buster) to switch between servicing different vehicles 30 based on the timestamp for the employee 50 moving way from a first vehicle 30 and the timestamp for the employee 50 approaching a second vehicle 30. The controller 110 may calculate an average idle time for the employee 50 based on the average of the idle time calculations for multiple interactions with a series of different vehicles 30.

In some embodiments, the controller 110 calculates a time spent ordering at the drive through unit 26 (e.g., a menu board) by a particular vehicle 30 based on the timestamp for the arrival of the vehicle 30 at the drive through unit 26 and the timestamp for the departure of the vehicle 30 from the drive through unit 26. The controller 110 may calculate an average time spent ordering at the drive through unit 26 based on the average of the total time spent at the drive through unit 26 calculations for multiple vehicles 30 at a given store 14.

In some embodiments, the controller 110 calculates a time spent at a payment window (e.g., a window 28 configured for taking payment for an order) by a particular vehicle 30 based on the timestamp for the arrival of the vehicle 30 at the payment window and the timestamp for the departure of the vehicle 30 from the payment window. The controller 110 may calculate an average time spent at the payment window based on the average of the total time spent at the payment window calculations for multiple vehicles 30 at a given store 14.

In some embodiments, the controller 110 calculates a time spent at a pick-up window (e.g., a window 28 configured for delivery of an order to a vehicle 30) by a particular vehicle 30 based on the timestamp for the arrival of the vehicle 30 at the pick-up window and the timestamp for the departure of the vehicle 30 from the pick-up window. The controller 110 may calculate an average time spent at the pick-up window based on the average of the total time spent at the pick-up window calculations for multiple vehicles 30 at a given store 14.

The foregoing calculations can be used to support informed decision making for the drive-through system. Information from the controller 110 can be utilized to inform decision-making to reduce the average time spent by a customer, e.g., to reduce the average time spent ordering. Information from the controller 110 can be utilized to inform decision-making to reduce the idle time, average time spent ordering, average time spent at the payment window, average time spent at the pick-up window, etc.

In some embodiments, the controller 110 calculates other performance metrics. By way of example, the controller 110 may calculate the time between when a vehicle 30 enters the system 10 and when the vehicle 30 is approached by an employee 50. By way of another example, the controller 110 may calculate the time that a customer waits in the system 10 before exiting the system 10 (e.g., through an escape lanes 23) without placing and receiving an order (i.e., an early exit). By way of another example, the controller 110 may calculate a number of early exits due to drink delivery. By way of another example, the controller 110 may calculate a number of orders that are delivered through windows 28 and a number of orders that are delivered by food runners. By way of another example, the controller 110 may calculate a number of early exits where the customer does not place an order. By way of another example, the controller 110 may calculate a total number of early exits and a total number of fulfilled orders.

In some embodiments, the controller 110 associates performance metrics with corresponding time periods. By way of example, the controller 110 may associate a performance metric with a particular time of service (e.g., breakfast, lunch, dinner, late night, etc.). By way of example, the controller 110 may associate a performance metric with a particular day of the week or month of the year. By associating a performance metric with a particular time period, the controller 110 may permit comparison of how the system 10 performs across different time periods.

In some embodiments, the controller 110 permits comparison of performance metrics against predefined goals (e.g., threshold times). By way of example, a manager may set a predetermined goal (e.g., a target time) for a particular performance metric and compare the measured performance metric against the goal (e.g., to determine if the measured performance metric is better or worse than the goal). The predetermined goal may be set for a particular store 14 or across multiple stores 14 (e.g., for an entire brand) as an acceptable standard for service. By identifying areas where the performance metric fails to meet the goal, the controller 110 may suggest areas for potential improvement to the customer experience. By way of example, the controller 110 may suggest a particular employee 50, a particular store 14, a particular stage of the drive through process, etc. where the performance metrics fail to meet the goal and should be addressed. By way of example, the controller 110 may note that a particular employee 50 takes longer than the goal to take a customer order and may suggest that the employee 50 reduce their greeting time.

In some embodiments, the controller 110 permits comparison of performance metrics between different individuals or groups of individuals. The controller 110 may compare performance metrics between different employees 50, different shifts (e.g., breakfast shift vs lunch shift, Tuesday shift vs Wednesday shift, etc.), and/or different stores. The comparison may provide gamification of performance, encouraging positive behavior. By way of example, the controller 110 may generate a leaderboard comparing the performance of different employees 50, shifts, stores 14, or other groups.

### Graphical User Interfaces

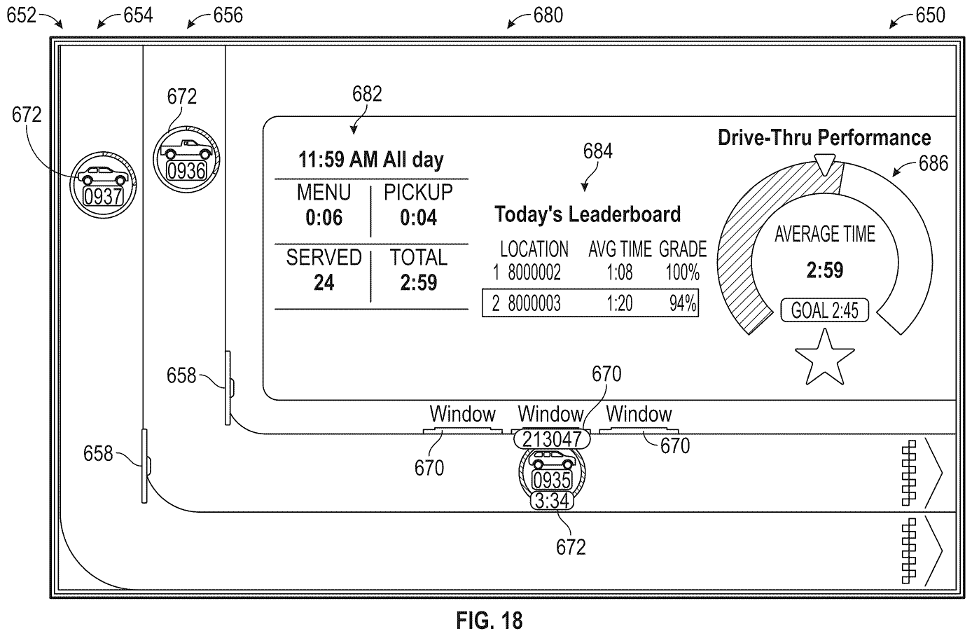

Referring to FIGS. 18-36, the control system 100 may provide various graphical user interfaces (GUIs) to communicate information to and/or receive information from various users of the system 10 (e.g., employees 50, managers, etc.). The GUIs may each communicate different information, depending upon which user is intended to interact with the GUI and what task the user is intended to perform. The GUIs may be generated by the controller 110 and displayed by the order taking stations 140 or through other user interfaces. Alternatively, the control system 100 may provide different GUIs or operate without providing any GUIs.

Referring to FIG. 18, a system overview interface or performance summary interface is shown as GUI 650. The GUI 650 provides information regarding the current status of the system and performance metrics. The GUI 650 may be used by a manager or generally available to all employees 50 of the store 14 to evaluate the status and performance of the store 14. The GUI 650 may facilitate making rapid, informed decisions.

The GUI 650 includes a first section, shown as drive through mockup 652, that shows a current status of the system 10. The mockup 652 includes a pair of indicators, shown as lane 654 and lane 656. The lane 654 and the lane 656 may each represent a top-down view of one or more of the lanes of the system 10 (e.g., the entry lane 18, the order lanes 20, the pickup lane 22, the one or more escape lanes 23, etc.). By way of example, the lane 654 may represent the first order lane 20a and the one or more escape lanes 23, and the lane 656 may represent the second order lane 20b and the pickup lane 22. A series of first icons, shown as menu boards 658, are positioned along the lane 654 and the lane 656 and represent the positions of the drive through units 26. A series of second icons, shown as windows 670, are positioned along the lane 656 and represent the positions of the windows 28 along the store 14. A series of third icons, shown as vehicle icons 672, are positioned along the lane 654 and the lane 656 and represent the positions of the vehicle 30.

The controller 110 may automatically update the vehicle icons 672 to indicate the current status of the vehicle 30 detected by the vision system 200. The controller 110 may position each vehicle icon 672 relative to the lane 654, the lane 656, the menu boards 658, and the windows 670 to illustrate the determined position of a corresponding vehicle 30 within the system 10. By way of example, each zone 470 may correspond to a different position of a vehicle icon 672 in the GUI 650. When a vehicle 30 leaves the system 10, the corresponding vehicle icon 672 may be removed. Accordingly, by reviewing the GUI 650, a user may determine how many vehicles 30 are present and where the vehicle 30 are currently located within the system 10.

Each vehicle icons 672 may include visual indicators that indicate different information about the corresponding vehicle 30. As shown, each vehicle icon 672 includes a unique identifier (e.g., an identification number, the VID) that uniquely identifies the corresponding vehicle 30. Each vehicle icon 672 includes an image of a vehicle corresponding to the determined type of vehicle (e.g., different images for SUVs, trucks, sedans, motorcycles, etc.). Each vehicle icon 672 includes an arcuate bar and/or a timer indicating a wait time that the corresponding vehicle 30 has been waiting (i.e., a total time spent in the system 10, time spent at the current location, etc.). As the vehicle 30 waits, the arcuate bar may fill, the timer may count up, and the vehicle icon 672 (e.g., a portion of the vehicle icon 672) may change color to indicate the wait time. Accordingly, the GUI 650 facilitates a user quickly identifying each vehicle 30 and how long the vehicle 30 has been waiting.

When an order corresponding to a vehicle 30 has been received, the controller 110 may update the corresponding vehicle icon 672 to include a unique identifier (e.g., an order ID number) that uniquely identifies the order. One such example of this is shown in the vehicle icon 672 near the bottom of FIG. 18. The controller 110 may change a color of the vehicle icon 672 (e.g., of a portion of the vehicle icon 672) to indicate when the order is ready for delivery to the customer and when the order has been fulfilled (e.g., transitioning from white to yellow to green). Accordingly, the vehicle icon 672 may indicate which order should be delivered to each vehicle 30 and the current status of that order.

The GUI 650 includes a second section, shown as performance metric section 680, that shows (e.g., in text, graphically, etc.) various performance metrics of the system 10. Although a specific set of performance metrics are shown in FIG. 18, the performance metric section 680 may be used to illustrate any performance metrics available to the controller 110. A first part of the performance metric section 680, shown as performance table 682, uses text to indicate a first set of performance metrics, including the average time spent ordering at the drive through unit 26, the average time spent at a pick-up window, the average total time spent, and the number of customers served that day. A second part of the performance metric section 680, shown as leaderboard 684, shows a comparison of the average total time spent for different stores 14. The leaderboard 684 assigns a grade or score for each store 14 based on a comparison of the average total time spent relative to a predetermined goal time. Alternatively, the grade may indicate a percentage of customers that are serviced at or under the established goal time. The leaderboard 684 may only display data from stores 14 that have served at least a threshold number of customers that day (e.g., to confirm that the store 14 is open and operating). A third part of the performance metric section 680, shown as performance graph 686, includes an arcuate graph that shows a comparison of the average total time spent with a predetermined goal time.

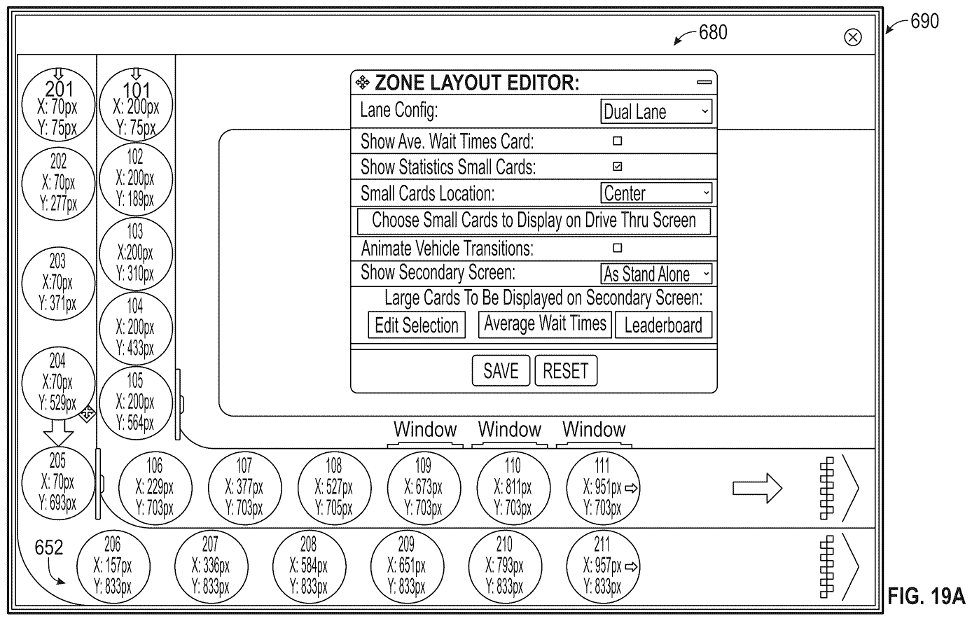

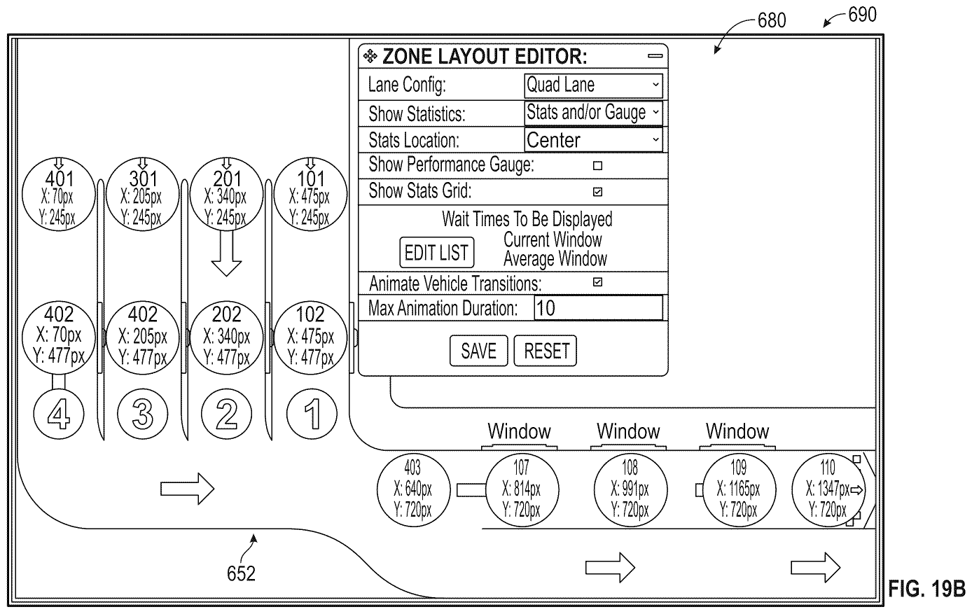

FIGS. 19A and 19B illustrate an editing interface, shown as GUI 690, that permits editing the information that is shown by the GUI 650 and how the information is presented. The GUI 690 permits editing the number of lanes 654 and 656, the positions of the zones 470, the quantity and positions of the menu boards 658 and the windows 670, and other parts of the drive through mockup 652. The GUI 690 further permits editing which performance metrics are shown in the performance metric section 680 and how the performance table 682, the leaderboard 684, and performance graph 686 are arranged.

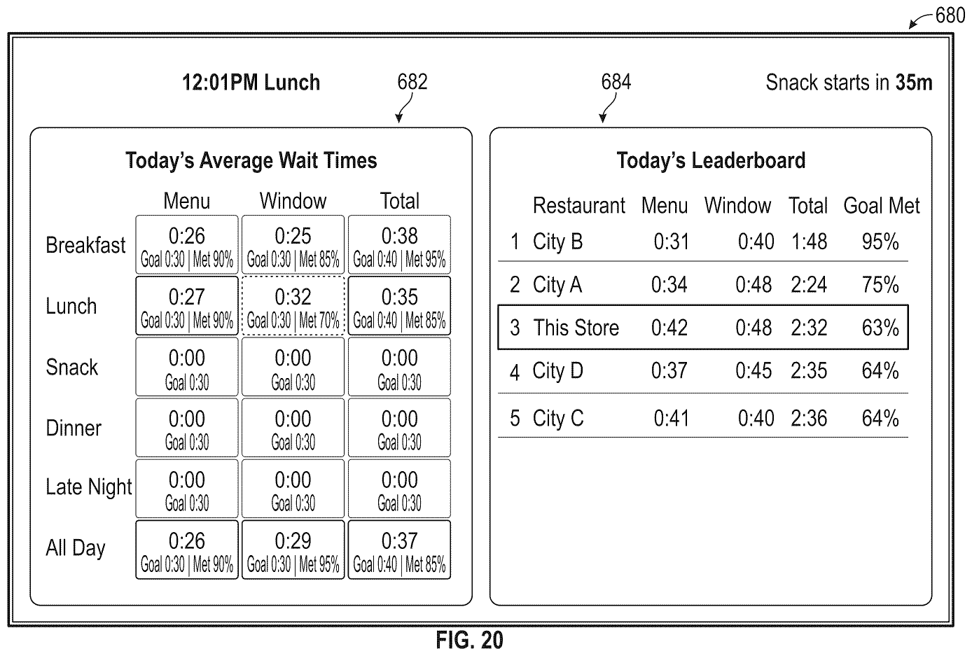

FIG. 20 illustrates an alternative embodiment of the performance metric section 680. The performance metric section 680 of FIG. 20 may be displayed along with the drive through mockup 652 or as a standalone interface. The performance metric section 680 of FIG. 20 includes a performance table 682 and a leaderboard 684. The performance table 682 includes (a) the average time spent ordering at the drive through unit 26, the average time spent at a pick-up window, and the average total time spent, (b) a predetermined goal time, and (c) a grade comparing the performance metrics to corresponding predetermined goal times for various time periods including breakfast, lunch, snack, dinner, late night, and the day overall. The performance table 682 may change colors of sections corresponding to particular performance metrics (e.g., average wait time at a window 28 for the lunch period) to indicate the performance relative to the goal time. By way of example, a grade below a threshold grade may cause the section to turn red, while a grade meeting or exceeding the threshold grade may cause the section to turn green. The leaderboard 684 compares these same performance metrics, goal times, and grades across various stores 14.

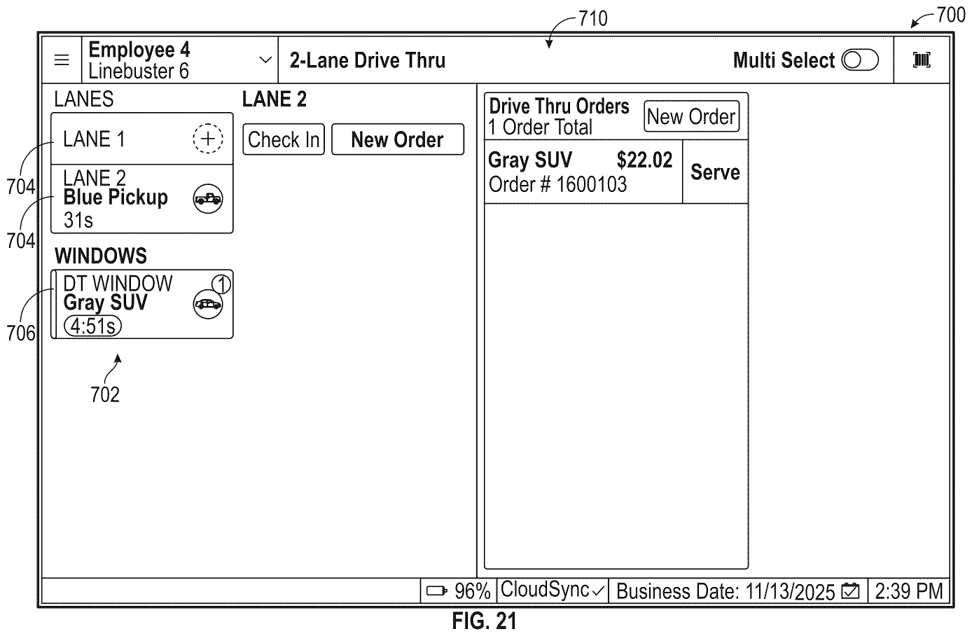

Referring to FIG. 21, a service point selector, window order taking interface, or window fulfillment interface is shown as GUI 700 according to an exemplary embodiment. The GUI 700 may be displayed on an order taking station 140 used by an employee 50 that manages (e.g., taking, recording, editing, marking as complete, etc.) orders at various service points (e.g., drive through units 26, windows 28, etc.) from within a window area 40. The GUI 700 may permit managing orders taken through a drive through unit 26 and/or fulfilled through a window 28. The GUI 700 may permit a single employee 50 or group of employees 50 to manage all of the drive through units 26 and/or all of the windows 28.

As shown in FIG. 21, the GUI 700 includes a first part, shown as service point selector 702. The service point selector 702 includes a series of icons, visual indicators, buttons, or sections including a pair of lane icons 704 and a window icon 706. The service point selector 702 may include one lane icons 704 for each order lane 20 and one window icon 706 for each window 28. Accordingly, each lane icon 704 corresponds to one of the order lanes 20 and each window icon 706 corresponds to one of the windows 28.

Each lane icon 704 and each window icon 706 visually indicates information about a vehicle 30 that the vision system 200 has determined to be in a zone 470 corresponding to that location. As shown, the lane icon 704 and the window icon 706 each include a vehicle label showing the color (e.g., red, blue, etc.) and type (e.g., pickup, SUV, etc.) of the vehicle 30. The lane icon 704 and the window icon 706 each include an image visually representing the vehicle 30. The image may be a generic image corresponding to the type of the vehicle 30 or may be the anonymized image data of the vehicle 30 produced in the method 300. The lane icons 704 and the window icon 706 each further indicate a wait time for each corresponding vehicle 30 (e.g., a total wait time, an amount of time that the vehicle 30 has been waiting at the window 28 or the drive through unit 26, etc.).

In response to pressing one of the lane icons 704 or the window icon 706, the GUI 700 brings up an order editing and fulfillment screen, shown as screen 710. The screen 710 outlines any orders associated with the vehicle 30 that corresponds with the lane icon 704 or the window icon 706 pressed by the user. If no order has been placed for that vehicle 30, the screen 710 permits the user to enter a new order. If an order already exists in association with that vehicle 30, the screen 710 permits the user to add another order, edit the existing order, or indicate that the existing order has been delivered to the customer and should be considered fulfilled. A user may switch between the lane icons 704 and the window icon 706 to manage orders at each service point of the system 10.

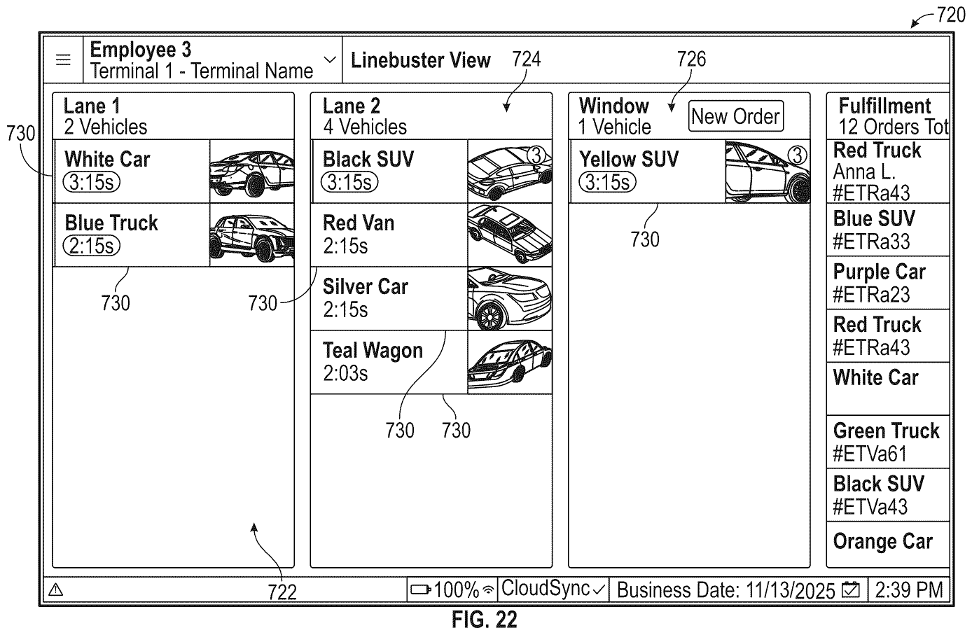

Referring to FIG. 22, a mobile order taking interface or line buster interface is shown as GUI 720 according to an exemplary embodiment. The GUI 720 may be displayed on an order taking station 140 used by an employee 50 that approaches vehicles 30 to manage orders from outside of a window area 40 (e.g., a line buster). Multiple order taking stations 140 may all display the GUI 720 or similar GUIs 720 to facilitate multiple employees 50 taking orders simultaneously.

The GUI 720 includes a series of sections or columns, shown as first lane column 722, second lane column 724, and pickup column 726. The first lane column 722 corresponds to the first order lane 20a, the second lane column 724 corresponds to the second order lane 20b, and the pickup column 726 corresponds to the pickup lane 22. Accordingly, the GUI 720 may have more or fewer columns depending upon the configuration of the system 10 (e.g., depending upon the number of order lanes 20 and the number of pickup lanes 22).

Each of the first lane column 722, the second lane column 724, and the pickup column 726 are populated with one or more icons or visual indicators, shown as vehicle icons 730. Each vehicle icon 730 corresponds to one of the vehicles 30 detected by the vision system 200. The position of each vehicle icon 730 within the first lane column 722, the second lane column 724, or the pickup column 726 depends upon the current position of the corresponding vehicle 30 within the system 10. The vehicle icons 730 are automatically populated into the GUI 720 based on the information about the vehicle 30 determined by the vision system 200. By way of example, when the vision system 200 detects that a vehicle 30 has entered the first order lane 20a, the controller 110 automatically adds a vehicle icon 730 to the first lane column 722. When the vision system 200 detects that a vehicle 30 has entered the second order lane 20b, the controller 110 automatically adds a vehicle icon 730 to the second lane column 724. When the vision system 200 detects that a vehicle 30 has entered the pickup lane 22 or is positioned adjacent a window 28, the controller 110 automatically adds a vehicle icon 730 to the pickup column 726.

Because the first order lane 20a and the second order lane 20b merge into the pickup lane 22, when a vehicle 30 exits one of the order lanes 20, the vehicle 30 then enters the pickup lane 22. The vehicle 30 may remove the corresponding vehicle icon 730 from the first lane column 722 or the second lane column 724 and add the vehicle icon 730 to the pickup column 726. When a vehicle 30 exits the system 10, the controller 110 may remove the corresponding vehicle icon 730 entirely.

Each vehicle icon 730 visually indicates information about the corresponding vehicle 30. As shown, the vehicle icons 730 each include a vehicle label showing the color (e.g., red, blue, etc.) and type (e.g., pickup, SUV, car, truck, van, wagon, etc.) of the vehicle 30. The lane vehicle icons 730 each include an image visually representing the vehicle 30. The image may be a generic image corresponding to the type of the vehicle 30 or may be the anonymized image data of the vehicle 30 produced in the method 300, ensuring privacy of customers and employees. The vehicle labels and images may facilitate a user quickly visually identifying a vehicle 30 that corresponds to the vehicle icon 730.

The lane icons 704 and the window icon 706 each further indicate a wait time for each corresponding vehicle 30 (e.g., a total wait time, an amount of time that the vehicle 30 has been waiting at the window 28 or the drive through unit 26, etc.). If the wait time exceeds a threshold, the vehicle icon 730 may change color to indicate this. By way of example, no color may indicate that the vehicle 30 has been waiting a short period of time. A yellow coloring may indicate that the wait time has exceeded a warning threshold. A red coloring may indicate that the wait time has exceeded an overdue threshold, and action should be taken immediately. A visual indicator within each vehicle icon 730 (e.g., a number within a circle) may indicate the number of orders associated with the corresponding vehicle 30 (e.g., zero, one, three, etc.). Accordingly, the GUI 720 permits a user to visually monitor the progress of all of the vehicles 30 within the system 10 from a single interface.

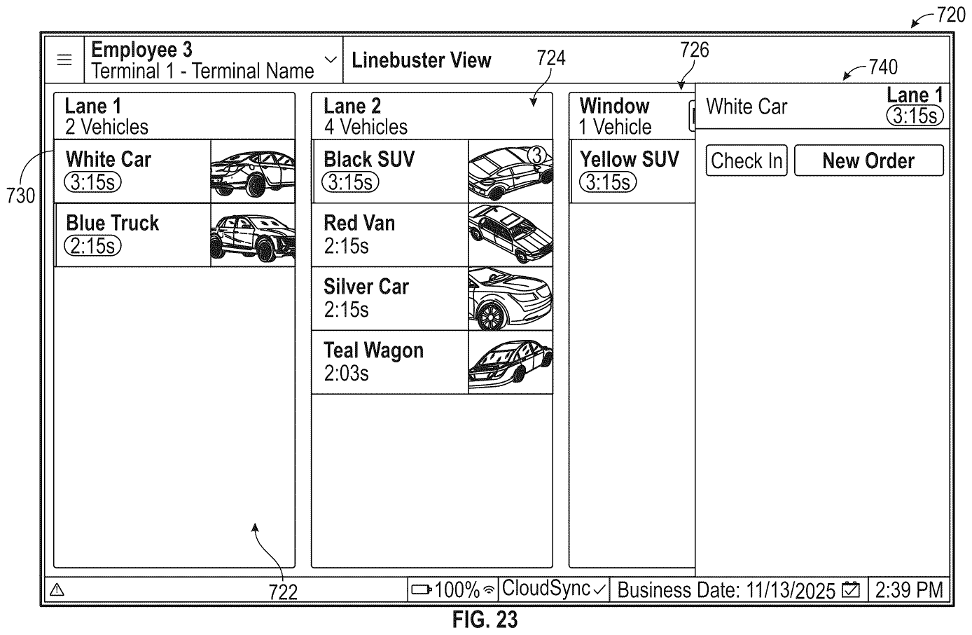

Referring to FIG. 23, the GUI 720 is shown after selecting a vehicle icon 730 that does not currently have an associated order. In response to the selection of the vehicle icon 730, the GUI 720 displays an order screen 740 corresponding to the vehicle of the selected vehicle icon 730. Because there are no orders currently associated with the vehicle 30, the order screen 740 is empty. The order screen 740 includes a “check in” button that permits checking in an online order for the vehicle 30 and a “new order” button that permits generating a new order for the vehicle 30.

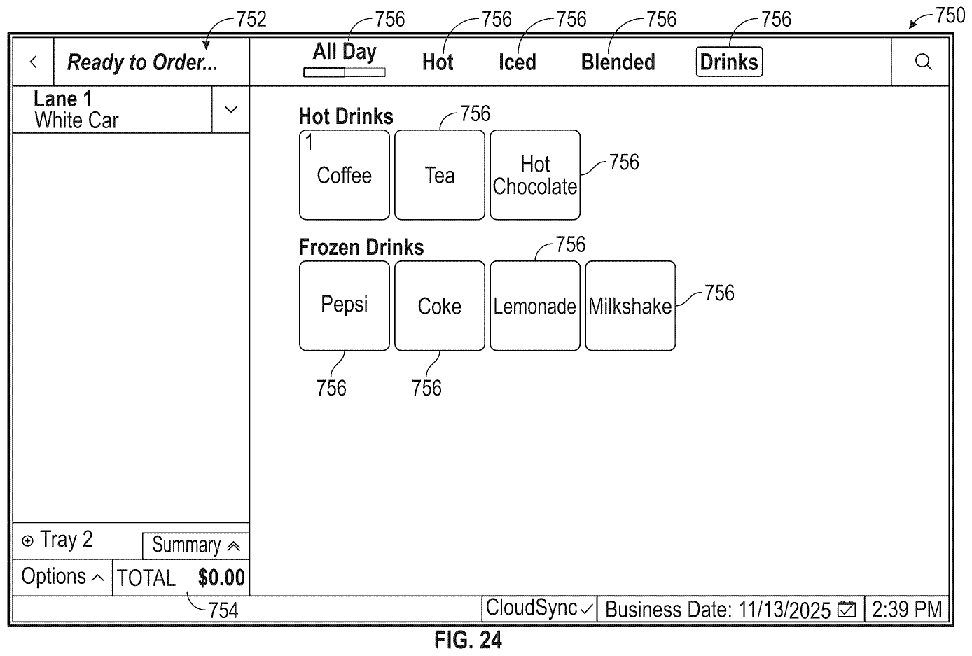

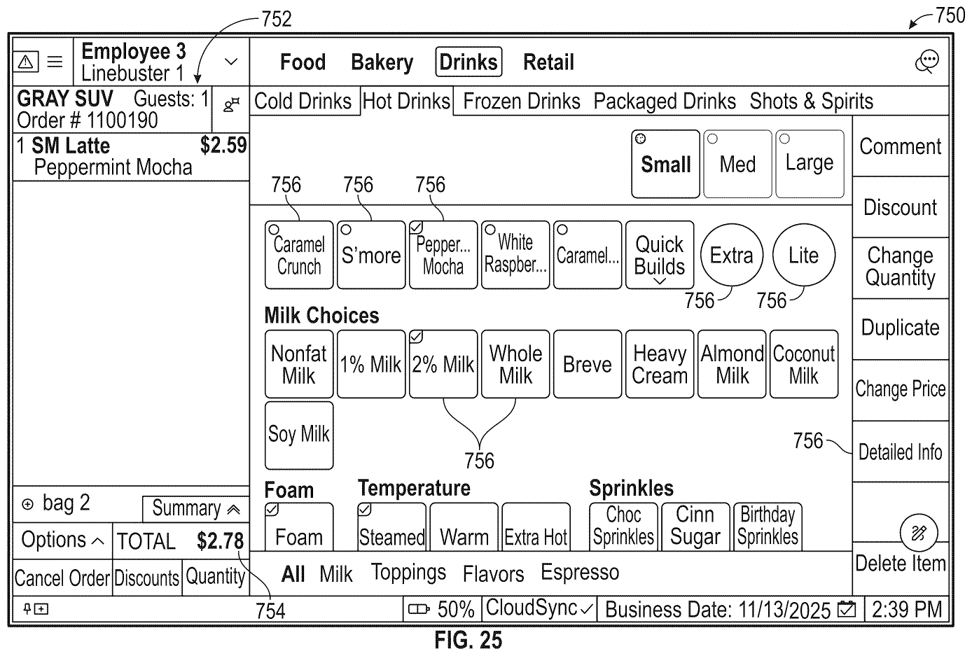

Referring to FIG. 24, in response to selecting the “new order” button on the GUI 720, the order taking station 140 displays an order customization screen or item selection interface, shown as GUI 750. FIG. 25 illustrates an alternative embodiment of the GUI 750. The GUI 750 permits a user to customize an order by adding, removing, or modifying items for purchase. The GUI 750 may permit selecting or modifying item size, price, cook level, ingredients, item type, item quantity, or other aspects of the order. The GUI 750 includes a first part or section, shown as current order area 752. The current order area 752 indicates the current items included in the order (e.g., item type, item quantity, modifications to the items, item price, etc.). Below the current order area 752 is a total cost indicator, shown as price indicator 754, that indicates the total cost of the current order. Similar GUIs may be utilized by any of the order taking stations 140 (e.g., order taking stations 140 used by the line busters, order taking stations 140 by the windows 28, order taking stations 140 within a front counter or dine-in area of the store 14, etc.). A GUI that services a dine-in area of the store 14 may permit the user to select between preparing the order for dine-in or carry out.

The GUI 750 further includes a series of order customization inputs or icons, shown as buttons 756. The buttons 756 each permit the user to make a corresponding customization to the order. By way of example, the buttons 756 may each permit the user to select an item to add to the order, change the quantity of an item, modify an item (e.g., to add or remove an ingredient, to change a cooking preference, etc.), remove an item from the order, or otherwise modify the order. When the order is finalized, the user may confirm the price total through the price indicator 754 and save the order in association with the vehicle 30.

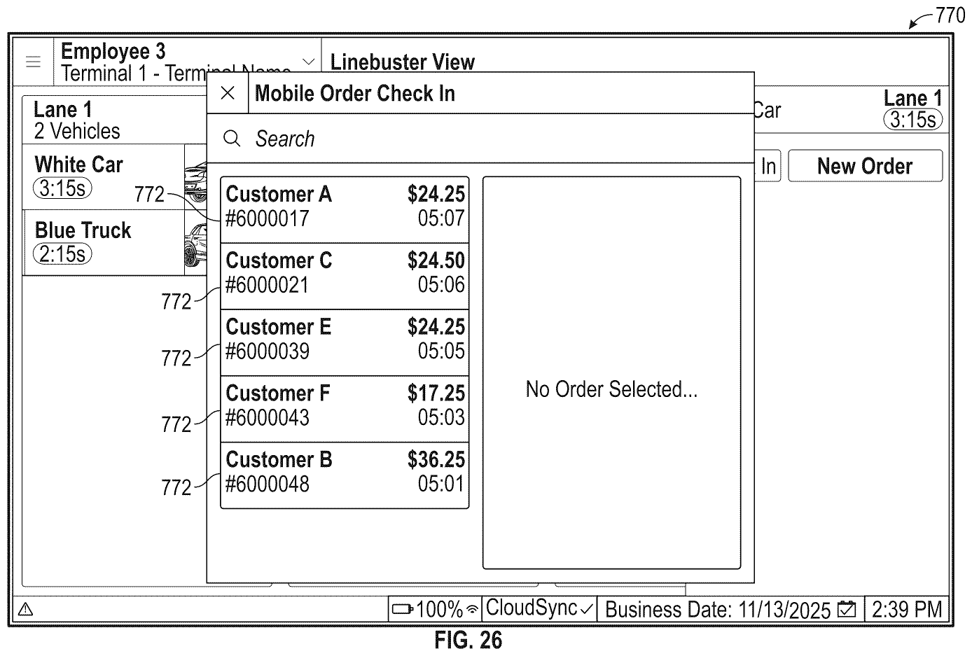

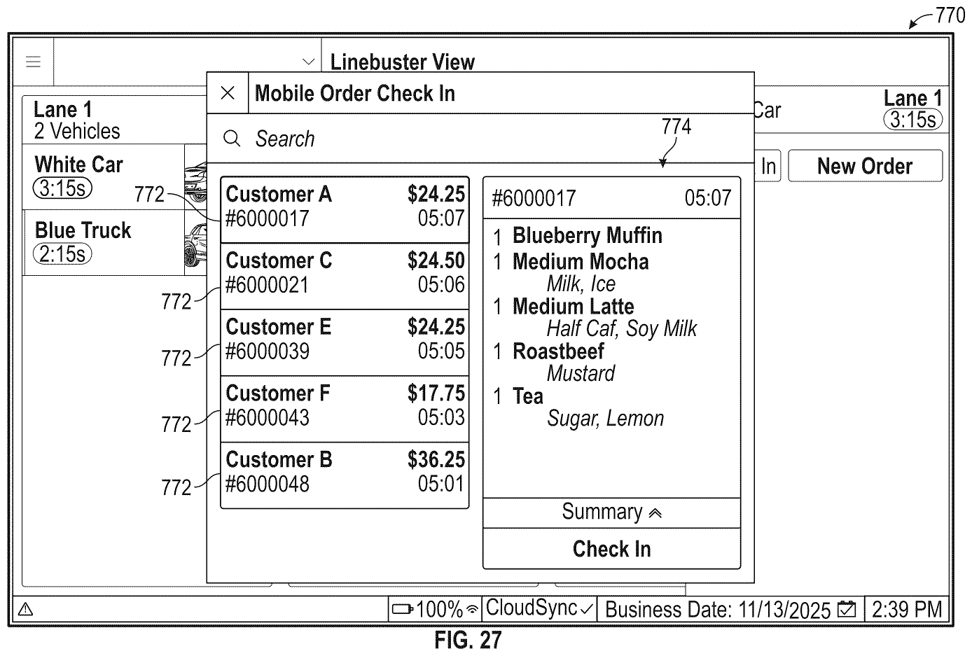

Referring to FIGS. 26 and 27, in response to selecting the “check in” button on the GUI 720, the order taking station 140 displays an order selection screen or mobile order check in interface, shown as GUI 770. The GUI 770 permits the selection of a mobile order to associate with the vehicle 30. The mobile orders may be retrieved from the order database 150 and displayed by the GUI 770 after submission through a user device 152.

The GUI 770 includes a series of icons or visual indicators, shown as mobile order icons 772. The mobile order icons 772 each correspond to a mobile order and provide information regarding the mobile order. As shown, each mobile order icons 772 displays an order number, a time that the order was placed, a customer name associated with the mobile order, and a total cost of the mobile order. The customer may provide one or more of these pieces of information to the user, and the user may select one of the mobile orders based on the provided information. As shown in FIG. 27, in response to selecting a mobile order icon 772, the GUI 770 populates a detailed order area 774 with a full listing of the items included in the mobile order. The user may select “check in” to associate the mobile order with the vehicle 30.

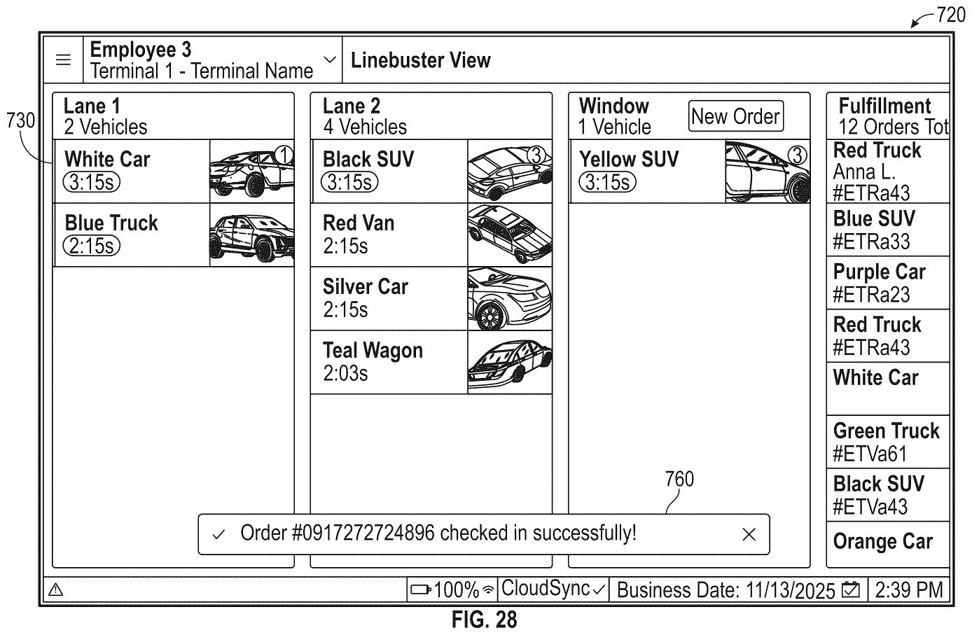

As shown in FIG. 28, in response to successfully associating a mobile order with the vehicle 30, the order taking station 140 returns to the GUI 720. The GUI 720 updates the vehicle icon 730 associated with the vehicle 30 to indicate that an order has been associated with the vehicle 30. The GUI 720 additionally provides a notification 760 indicating that the mobile order has been successfully checked in (e.g., associated with the vehicle 30).

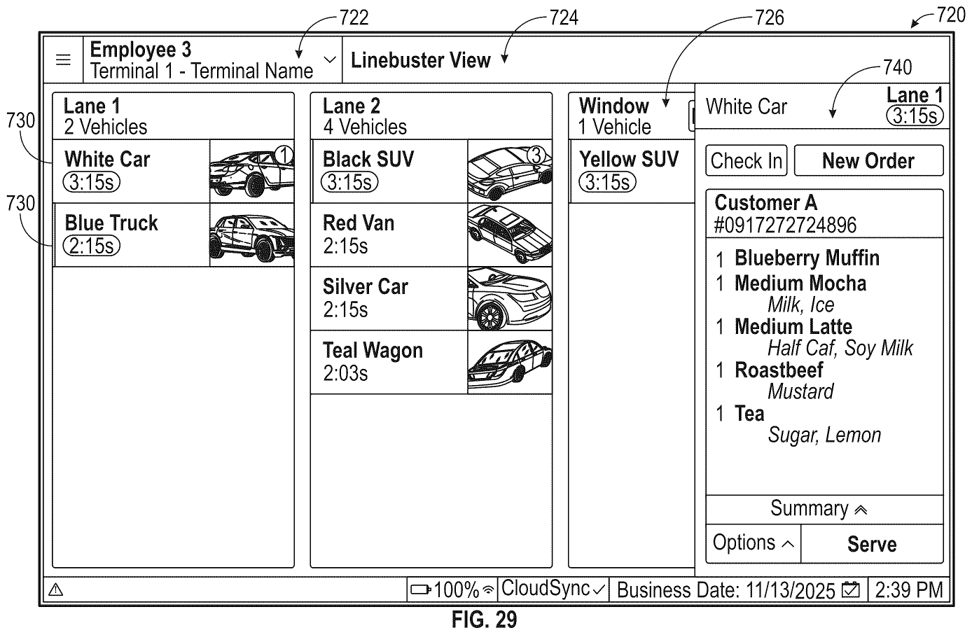

As shown in FIG. 29, once an order has been associated with a vehicle 30, selecting the corresponding vehicle icon 730 causes the order to be shown in the order screen 740. The order screen 740 shows the items included in the order (e.g., item type, item quantity, modifications to the items, item price, etc.). From the order screen 740, the user may then add another order, modify the order, or indicate that the order is being served. By selecting “serve,” the controller 110 may register that the order has been fulfilled.

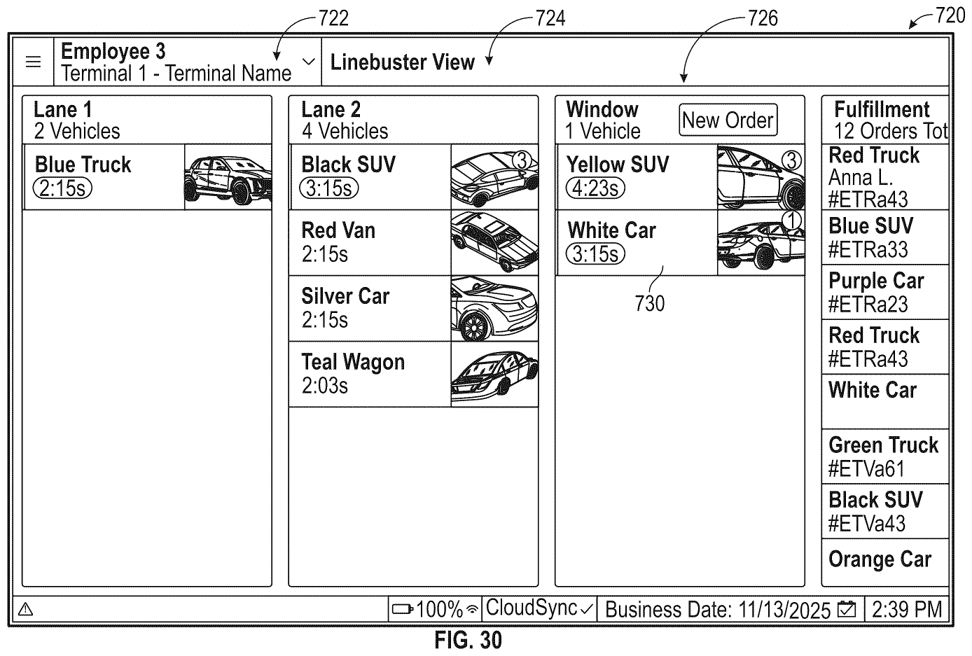

FIG. 30 illustrates the change in the GUI 770 due to movement of a vehicle 30. Specifically, when comparing FIGS. 29 and 30, the vehicle icon 730 corresponding to the white car is shown to have moved from the first lane column 722 to the pickup column 726. The controller 110 may automatically update the GUI 720 in this way in response to the corresponding vehicle 30 moving from the order lane 20a to the pickup lane 22.

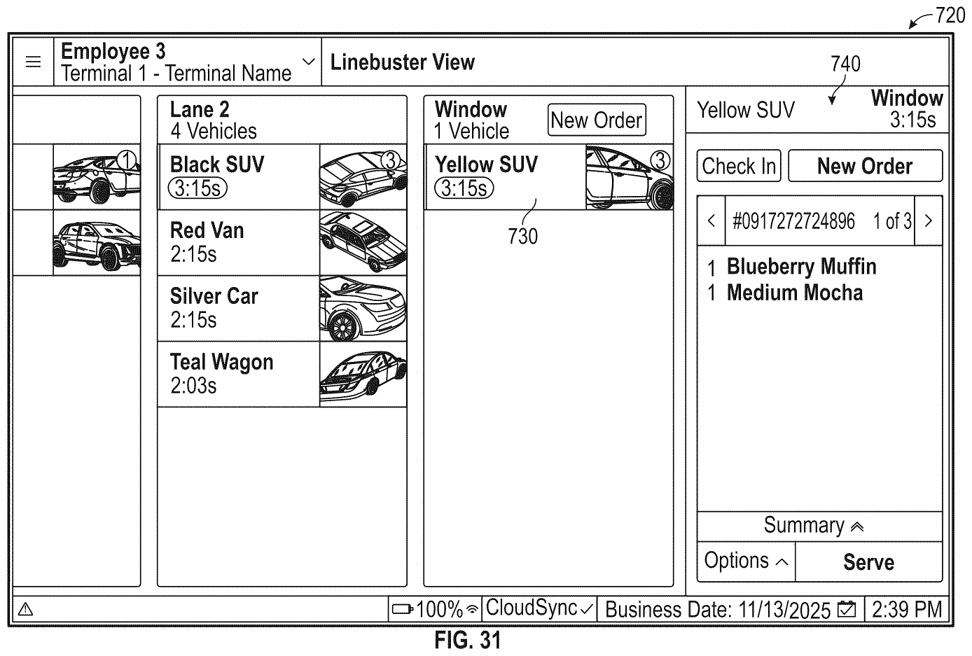

FIG. 31 illustrates the GUI 720 showing the order screen 740 when a vehicle 30 is associated with multiple orders. By way of example, the vehicle 30 may be associated with a pair of mobile orders (e.g., for two different customers within the vehicle 30), and the driver of the vehicle 30 may place an additional order with an employee 50. When multiple orders are associated with a single vehicle 30, the order screen 740 may permit selecting between the orders. By way of example, tapping an on-screen arrow may scroll the order screen 740 through different orders. Accordingly, even with multiple orders, the order screen 740 may permit modifying, deleting, or serving any of the existing orders and adding one or more new orders.

Referring to FIG. 22, an order taking interface or line buster interface, shown as shown as GUI 720. The GUI 720 may be displayed on an order taking station 140 used by an employee 50 that approaches vehicles 30 to manage orders from outside of a window area 40 (e.g., a line buster). Multiple order taking stations 140 may all display the GUI 720 or similar GUIs 720 to facilitate multiple employees 50 taking orders simultaneously.

The GUI 720 includes a series of sections or columns, shown as first lane column 722, second lane column 724, and pickup column 726. The first lane column 722 corresponds to the first order lane 20a, the second lane column 724 corresponds to the second order lane 20b, and the pickup column 726 corresponds to the pickup lane 22. Accordingly, the GUI 720 may have more or fewer columns depending upon the configuration of the system 10 (e.g., depending upon the number of order lanes 20 and the number of pickup lanes 22).

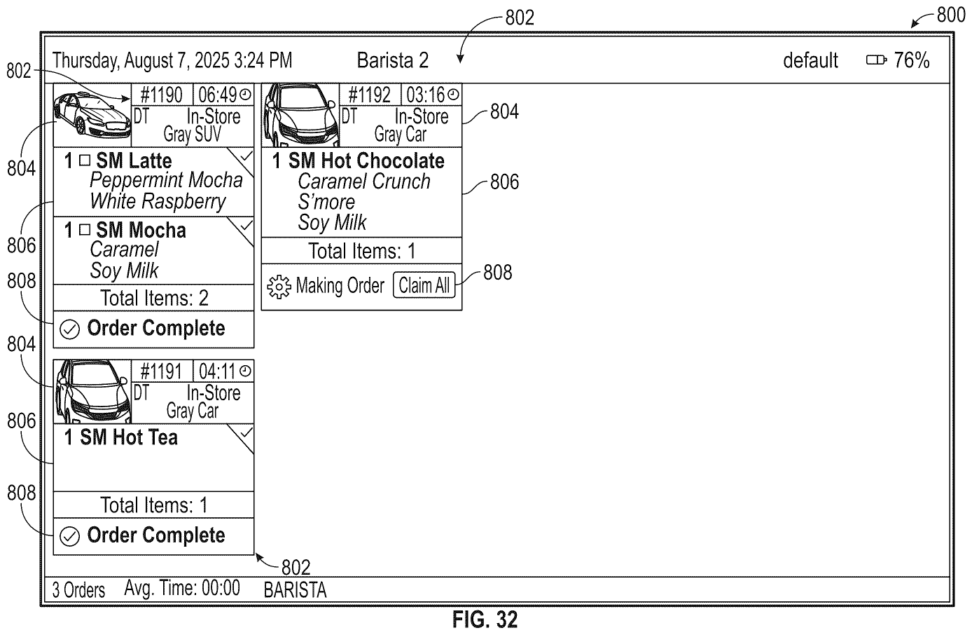

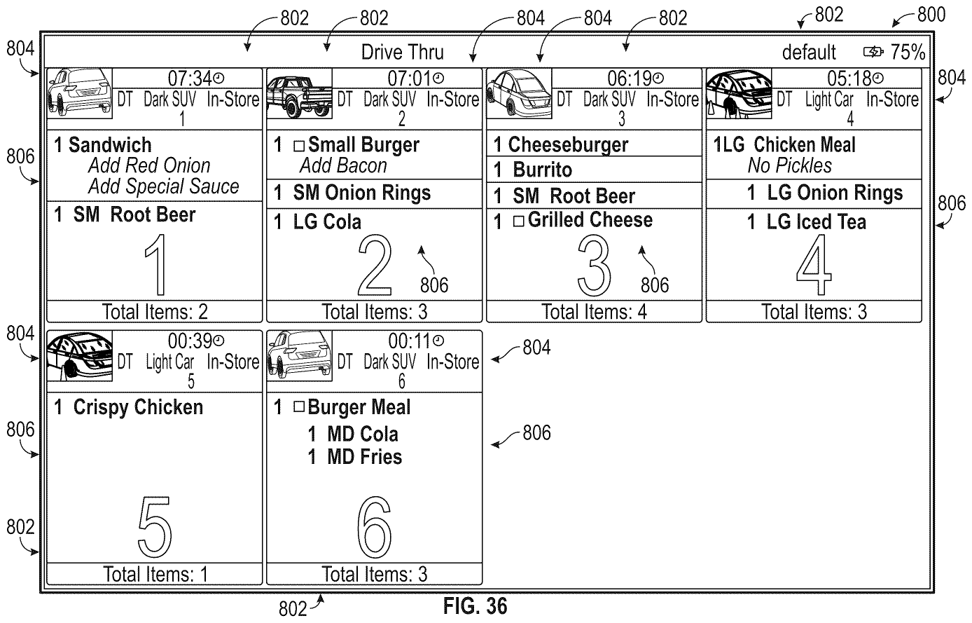

Referring to FIG. 32, an order preparation interface or kitchen interface is shown as GUI 800 according to an exemplary embodiment. FIG. 36 illustrates an alternative embodiment of the GUI 800 including a greater number of orders. The GUI 800 may be displayed on an order taking station 140 within the kitchen 42. Accordingly, the GUI 800 may be used by an employee 50 that prepares orders that will be served to customers. The GUI 800 may facilitate order preparation by indicating types, quantities, and modifications of items that should be included in each order. The GUI 800 may also facilitate assigning orders to specific employees 50 within the kitchen 42 and indicating when the orders are prepared.

As shown in FIG. 32, the GUI 800 includes a series of sections or visual indicators, shown as order sections 802, each corresponding to an order. The controller 110 may control the GUI 800 to provide an order section 802 for each order that has been placed but not prepared, each order that is in the process of being prepared, and each order that is ready to be delivered to the customer. Accordingly, order sections 802 may be added as new orders are placed and removed as orders are fulfilled.

As shown, each order section 802 includes a vehicle section 804, an order section 806, and an order status section 808. The vehicle section 804, the order section 806, and the order status section 808 are shown as stacked horizontal section. In other embodiments, the vehicle section 804, the order section 806, and the order status section 808 are otherwise arranged.

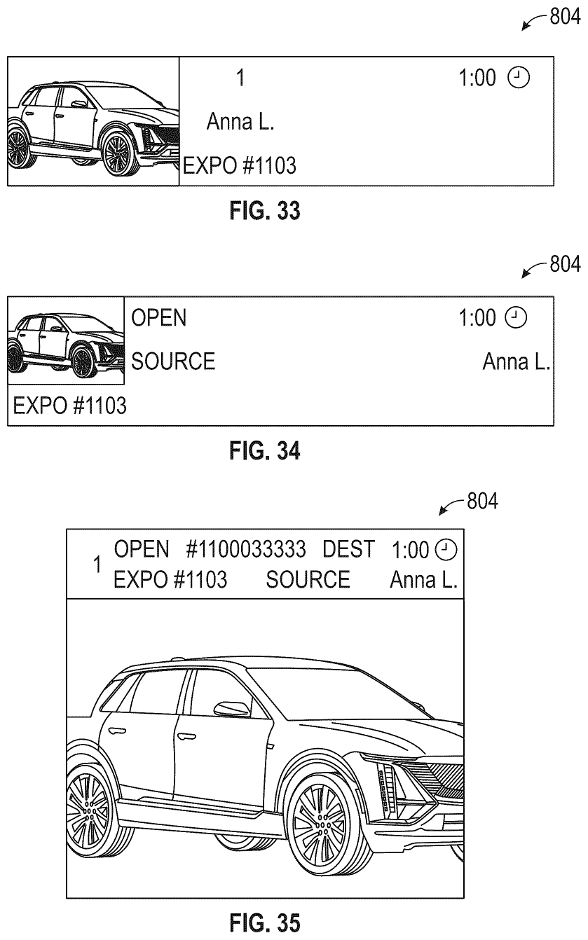

Referring to FIG. 32, the vehicle section 804 provides information that facilitates identifying the customer and the vehicle 30 associated with each order. The information may be similar and similarly presented to the information provided by the vehicle icon 730. The vehicle section 804 includes an anonymized image of the vehicle 30, a vehicle label, and a wait time for the vehicle 30. The vehicle section 804 an order number uniquely identifying the order. FIGS. 33-35 illustrate various alternative layouts of the vehicle section 804.

As shown in FIG. 32, the order section 806 provides a list of the items included in the order (e.g., item type, item quantity, modifications to the items, item price, etc.). The order section 806 may further indicate a status of each individual item (e.g., whether the item has been prepared, whether the item has been staged for delivery to a customer, etc.). The order status section 808 indicates a status of the order (e.g., placed by not yet assigned to an employee 50, assigned to an employee 50 and being prepared, complete and ready to be delivered to the customer, etc.).

As shown in FIGS. 18-36, the controller 110 provides various graphical user interfaces that provide visual identifying information that identifies a vehicle. The visual identifying information may include the vehicle label, an image of the vehicle 30, the VID, or other information that communicates an identify of a specific vehicle to a user. Beneficially, this may facilitate a user associating on-screen information (e.g., the content of an order, a length of time that a vehicle 30 has been waiting) with a particular vehicle in their surrounding environment.

The aforementioned systems and methods can be utilized in connection with one or more drive-through ordering systems, point-of-sale systems, and drive-through interfaces for facilitating orders. Suitable systems, methods, and techniques are set forth, for example, in U.S. Pat. No. 11,244,681, granted on Feb. 8, 2022, U.S. Pat. No. 11,741,529, granted on Aug. 29, 2023, U.S. Pat. No. 12,400,279, granted on Aug. 26, 2025, U.S. Pat. No. 12,381,673, granted on Aug. 5, 2025, U.S. Pat. No. 12,327,230, granted on Jun. 10, 2025, International Publication No. WO2025/166298, filed on Jan. 31, 2025, and International Application No. PCT/US2025/031066, filed on May 27, 2025. The entire contents of the aforementioned patents and patent applications are incorporated herein by reference for background information and the systems, components, processes and techniques disclosed therein.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be achieved with the two members coupled directly to each other, with the two members coupled to each other using a separate intervening member and any additional intermediate members coupled with one another, or with the two members coupled to each other using an intervening member. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical and/or electrical.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The operations described herein may be performed via computing code executed by processors in a distributed computing environment. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. One or more processors can be provided to individually or collectively carry out the operations described herein. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods can be accomplished with standard programming techniques with rule-based logic and other logic to accomplish the various connection steps, processing steps, comparison steps, and decision steps.

It is important to note that the construction and arrangement of the drive through system 10 as shown in the various exemplary embodiments is illustrative only. Additionally, any element disclosed in one embodiment may be incorporated or utilized with any other embodiment disclosed herein.

What is claimed is:

1. A drive through system comprising:
a sensor configured to obtain image data including an image of a lane of the drive through system; and
a controller configured to:
determine whether the image includes a vehicle;
identify, within the image, a personally identifiable feature;
modify the image to remove the personally identifiable feature from the image and generate an anonymized image; and
in response to a determination that the image includes a vehicle, provide the anonymized image to a remote device along with a request for the remote device to determine a characteristic of the vehicle.

2. The drive through system of claim 1, wherein the personally identifiable feature is at least one of a face of a human or a license plate.

3. The drive through system of claim 2, wherein the personally identifiable feature is the license plate, and wherein the license plate is a license plate of the vehicle.

4. The drive through system of claim 3, wherein the controller is further configured to:
identify a region of interest of the image that contains the vehicle; and
remove a portion of the image outside of the region of interest when generating the anonymized image.

5. The drive through system of claim 1, wherein the characteristic of the vehicle includes at least one of a vehicle type, a vehicle color, a vehicle make, or a vehicle model.

6. The drive through system of claim 5, wherein the request is a request for the remote device to determine the vehicle type and the vehicle color.

7. The drive through system of claim 1, wherein the image is a first image and the vehicle is a first vehicle, and wherein the controller is configured to:
receive a second image from the sensor, the second image including a second vehicle; and
in response to a determination that the remote device cannot be reached, analyze the second image to determine a characteristic of the second vehicle.

8. The drive through system of claim 1, wherein the image is a first image captured by the sensor, and wherein the controller is configured to:
receive a second image captured by the sensor after the first image has been captured;
receive a third image captured by the sensor after the second image has been captured; and
delete the second image in response to receiving the third image prior to processing the second image.

9. The drive through system of claim 1, wherein the image is a second image, and wherein the controller is configured to:
receive a first image of the drive through system;
receive the second image, wherein the second image is captured the sensor after the first image has been captured;
compare the first image and the second image to determine whether a threshold amount of movement has occurred between the first image and the second image; and
determine whether the second image includes the vehicle in response to a determination that the threshold amount of movement has occurred.

10. The drive through system of claim 9, wherein the controller is configured to modify the image to both (a) remove the personally identifiable feature from the image and (b) remove a portion of the image where no motion occurred between the first image and the second image when generating the anonymized image.

11. The drive through system of claim 1, wherein the controller is configured to:
identify, within the image, a human;
determine at least one of (a) a position of the human or (b) an orientation of the human relative to the vehicle; and
provide an indication that the human is associated with the vehicle in response to a determination that at least one of (a) the human is within a predetermined area relative to the vehicle or (b) the human is facing toward the vehicle.

12. The drive through system of claim 11, wherein the controller is configured to:
determine both (a) the position of the human and (b) the orientation of the human relative to the vehicle; and
provide an indication that the human is associated with the vehicle in response to a determination that both (a) the human is within the predetermined area relative to the vehicle and (b) the human is facing toward the vehicle.

13. The drive through system of claim 11, wherein the controller is configured to receive an order from an order taking station associated with the human, and wherein the controller is configured to assign the order received from the order taking station to the vehicle.

14. The drive through system of claim 1, wherein the controller is configured to determine, based on the image, that the vehicle is present in a first predefined zone of a plurality of predefined zones.

15. The drive through system of claim 14, wherein the image is a first image, the image data is first image data, and the sensor is a first camera, further comprising a second camera configured to obtain second image data including a second image, and wherein the controller is configured to:
determine, based on the first image, that the vehicle is present in the first predefined zone at a first time; and
determine, based on the second image, that the vehicle is present in a second predefined zone of the plurality of predefined zones at a second time.

16. A drive through system comprising:
a sensor configured to obtain image data including an image showing a vehicle within the drive through system;
an order taking station configured to receive data corresponding to an order; and
a controller configured to:
determine, based on the image, a position of a vehicle;
receive the data corresponding to the order from the order taking station;
determine that the order should be associated with the vehicle based on the position of the vehicle; and
provide an indication that the order is associated with the vehicle.

17. The drive through system of claim 16, wherein the order taking station is configured to be operated by a human to enter the data corresponding to the order, and wherein the controller is configured to:
determine, based on the image, a position of the human; and
determine that the order should be associated with the vehicle based on the position of the vehicle and the position of the human.

18. The drive through system of claim 17, wherein the controller is configured to determine that the order should be associated with the vehicle in response to a determination that the human is within a predetermined area relative to the vehicle.

19. The drive through system of claim 16, wherein the controller is configured to control a user interface to provide a graphical user interface showing the order and a piece of visual identifying information that identifies the vehicle.

20. The drive through system of claim 16, wherein the image is a first image showing the vehicle within the drive through system at a first time, wherein the image data includes a second image showing the vehicle within the drive through system at a second time, and wherein the controller is configured to determine a wait time for the vehicle based on the first image and the second image.
